(19) United States
(12) Patent Application Publication
(10) Pub. No.: US 2008/0291305 A1
(43) Pub. Date: Nov. 27, 2008

(54) SOLID STATE IMAGING DEVICE AND CAMERA

(76) Inventors: Shigetaka Kasuga, Osaka (JP); Takahiko Murata, Osaka (JP); Takayoshi Yamada, Osaka (JP)

Correspondence Address: MCDERMOTT WILL & EMERY LLP, 600 13TH STREET, NW, WASHINGTON, DC, 20005-3096, US

(21) Appl. No.: 12/100,289

(22) Filed: Apr. 9, 2008

(30) Foreign Application Priority Data
May 23, 2007 (JP) 2007-136921

(51) Int. Cl. H04N 5/335

(52) U.S. Cl. 348/294; 348/E05.091

(57) ABSTRACT

In a solid state imaging device having a wide dynamic range, a pixel includes a photodiode that generates a charge in accordance with an intensity of incident light, signal generation units that generate a first voltage level in accordance with an amount of charge generated by the photodiode in an exposure period T1 and a second voltage level in accordance with an amount of charge generated by the photodiode in an exposure period T2, and signal composition units that composite the first and second voltage levels generated by the signal generation units.

### BACKGROUND OF THE INVENTION

1. Field of the Invention

The present invention relates to a solid state imaging device used in digital cameras etc., and in particular to technology for increasing dynamic range.

2. Description of the Related Art

The dynamic range of conventional solid state imaging devices is approximately 60 dB to 80 dB. There is a desire to increase the dynamic range of solid state imaging devices to approximately 100 dB to 120 dB, which compares with the human eye and silver salt film, or to even higher levels depending on use in vehicle-mounted cameras, surveillance cameras, etc. In view of this, patent document 1 discloses technology for capturing a plurality of frames at different exposure period lengths and compositing the captured frames. The range of luminance that can be captured in a frame varies according to the length of the exposure period. In the technology of patent document 1, the dynamic range is increased by compositing the plurality of frames that have different capturable luminance ranges.

Patent document 1: Japanese Patent Application Publication No. 2004-15298

However, in the technology of patent document 1, both a frame memory for storing the frames and a signal composition unit for compositing the frames are provided externally to the solid state imaging device, which increases the chip area and raises power consumption. Also, since the pixel signals of a plurality of frames must be read from the solid state imaging device in order to create a single frame, a lack of sufficient reading speed will reduce the frame rate.

### SUMMARY OF THE INVENTION

In view of this, an aim of the present invention is to provide a solid state imaging device and camera that have an increased dynamic range while minimizing the occurrence of the above problems.

The present invention is a solid state imaging device including a plurality of pixels, each pixel including: a photodiode that generates a charge in accordance with an intensity of incident light; a signal generation unit whose circuit structure includes a source follower, the signal generation unit being operable to, in a frame period, output from the source follower (i) a first voltage signal that corresponds to an amount of charge generated by the photodiode in a first exposure period and (ii) a second voltage signal that corresponds to an amount of charge generated by the photodiode in a second exposure period whose length is different from a length of the first exposure period; and a signal composition unit whose circuit structure includes one or more capacitors that hold the first voltage signal and second voltage signal output from the source follower, the signal composition unit being operable to composite the first voltage signal and second voltage signal held in the one or more capacitors.

The present invention is also a camera including a solid state imaging device, the solid state imaging device including a plurality of pixels, each pixel including a photodiode that generates a charge in accordance with an intensity of incident light; a signal generation unit whose circuit structure includes a source follower, the signal generation unit being operable to, in a frame period, output from the source follower (i) a first voltage signal that corresponds to an amount of charge generated by the photodiode in a first exposure period and (ii) a second voltage signal that corresponds to an amount of charge generated by the photodiode in a second exposure period whose length is different from a length of the first exposure period; and a signal composition unit whose circuit structure includes one or more capacitors that hold the first voltage signal and second voltage signal output from the source follower, the signal composition unit being operable to composite the first voltage signal and second voltage signal held in the one or more capacitors.

According to the above structure, the first voltage signal and second voltage signal are composited, thereby enabling a wider dynamic range. Also, the first and second voltage signals are composited in the pixel, thereby eliminating the need for a frame memory and signal composition unit that are external to the solid state imaging device. Furthermore, it is the composited pixel signal that is read from the pixel, thereby suppressing a reduction in frame rate.

Also, the first and second voltage signals are output from the source follower, which has the additional effect of suppressing variations between the levels of the held voltage signals even if there are variations between the capacitances of capacitors in the same pixel or capacitors in different pixels.

Also, the signal composition unit may (i) cause the first voltage signal to be held in a first capacitor from among the one or more capacitors, (ii) cause the second voltage signal to be held in a second capacitor from among the one or more capacitors, the first capacitor and the second capacitor having a same capacitance, and (iii) cause the first capacitor holding the first voltage signal and the second capacitor holding the second voltage signal to be connected in parallel.

According to this structure, the capacitances of the first and second capacitors are the same, thereby making the contribution rates of the first and second voltage signals the same.

Also, when performing the composition, the signal composition unit may give a predetermined weight to the first voltage signal and a predetermined weight to the second voltage signal.

This structure enables setting the contributions rates of the first and second voltage signals to desired contribution rates in the composited pixel signal. This enables raising the contrast in the high luminance range, raising the contrast in the low luminance range, etc.

Also, the signal composition unit may (i) cause the first voltage signal to be held in a first capacitor from among the one or more capacitors, (ii) cause the second voltage signal to be held in a second capacitor from among the one or more capacitors, the first capacitor and second capacitor having a different capacitance, and (iii) cause the first capacitor holding the first voltage signal and the second capacitor holding the second voltage signal to be connected in parallel.

According to this structure, the capacitances of the first and second capacitors are different, thereby enabling giving the first and second voltage signals different contribution rates in the composited pixel signal.

Also, the signal composition unit may include a plurality of the capacitors, each of the plurality of capacitors having a same capacitance, the first capacitor may be connected in parallel with a first number of capacitors from among the plurality of capacitors, and the second capacitor may be connected in parallel with a second number of capacitors from among the plurality of capacitors, the first number of capacitors and second number of capacitors being different in number.

According to this structure, the capacitances of the first and second capacitors are different, thereby enabling giving the first and second voltage signals different contribution rates in the composited pixel signal.

Also, the signal composition unit may be further operable to arbitrarily change the predetermined weight of the first voltage signal and the predetermined weight of the second voltage signal.

This structure enables dynamically changing the contribution rates of the first and second voltage signals. This enables raising the contrast in the high luminance range, low luminance range, etc. according to imaging conditions.

Also, in a first mode of the signal composition unit, the signal composition unit may (i) cause the first voltage signal to be held in a first capacitor from among the one or more capacitors, (ii) cause the second voltage signal to be held in a second capacitor from among the one or more capacitors, a capacitance of the second capacitor being smaller than a capacitance of the first capacitor, and (iii) cause the first capacitor holding the first voltage signal and the second capacitor holding the second voltage signal to be connected in parallel, and in a second mode of the signal composition unit, the signal composition unit may cause the first voltage signal to be held in the second capacitor, causes the second voltage signal to be held in the first capacitor, and cause the first capacitor holding the second voltage signal and the second capacitor holding the first voltage signal to be connected in parallel.

This structure enables dynamically changing the contribution rates of the first and second voltage signals by merely switching the capacitors that are to hold the first and second voltage signals.

Also, the signal composition unit may include a plurality of the capacitors, each of the plurality of capacitors having a same capacitance, in a first mode of the signal composition unit, the signal composition unit may (i) cause the first voltage signal to be held in a first number of capacitors from among the plurality of capacitors, (ii) cause the second voltage signal to be held in a second number of capacitors from among the plurality of capacitors, the second number of capacitors being smaller in number than the first number of capacitors, and (iii) cause the first number of capacitors holding the first voltage signal and the second number of capacitors holding the second voltage signal to be connected in parallel, and in a second mode of the signal composition unit, the signal composition unit may (iv) cause the first voltage signal to be held in a third number of capacitors from among the plurality of capacitors, (v) cause the second voltage signal to be held in a fourth number of capacitors from among the plurality of capacitors, the fourth number of capacitors being greater in number than the third number of capacitors, and (vi) cause the third number of capacitors holding the first voltage signal and the fourth number of capacitors holding the second voltage signal to be connected in parallel.

This structure enables dynamically changing the contribution rates of the first and second voltage signals by merely causing the number of capacitors that are to hold the first voltage signals to be different from the number of capacitors that are to hold the second voltage signals.

Also, in the signal composition unit, one of the one or more capacitors may be a signal holding capacitor, and another one of the one or more capacitors may be a signal composition capacitor, and the signal composition unit may (i) cause the first voltage signal to be held in the signal holding capacitor, (ii) in a first charging period, cause the signal composition capacitor to be charged by a first current that corresponds to the first voltage signal held in the signal holding capacitor, (iii) cause the second voltage signal to be held in the signal holding capacitor after the first charging period has elapsed, and (iv) in a second charging period whose length is the same as a length of the first charging period, cause the signal composition capacitor to be further charged by a second current that corresponds to the second voltage signal.

According to this structure, since the first and second voltage signals are successively composited using a signal composition capacitor, only one signal holding capacitor need be provided for holding the first and second voltage signals, which enables reducing the size of the pixel. Also, the first and second charging periods are the same length, thereby making the contribution rates of the first and second voltage signals the same.

Also, in the signal composition unit, one of the one or more capacitors may be a signal holding capacitor, and another one of the one or more capacitors may be a signal composition capacitor, and the signal composition unit may (i) cause the first voltage signal to be held in the signal holding capacitor, (ii) in a first charging period, cause the signal composition capacitor to be charged by a first current that corresponds to the first voltage signal held in the signal holding capacitor, (iii) cause the second voltage signal to be held in the signal holding capacitor after the first charging period has elapsed, and (iv) in a second charging period whose length is different from the first charging period, cause the signal composition capacitor to be further charged by a second current that corresponds to the second voltage signal held in the signal holding capacitor.

According to this structure, since the first and second voltage signals are successively composited using a signal composition capacitor, only one signal holding capacitor need be provided for holding the first and second voltage signals, which enables reducing the size of the pixel. Also, the first and second charging periods are different, thereby enabling giving the first and second voltage signals different contribution rates in the composited pixel signal.

Also, in the signal composition unit, one of the one or more capacitors may be a signal holding capacitor, and another one of the one or more capacitors may be a signal composition capacitor, and the signal composition unit may (i) cause the first voltage signal to be held in the signal holding capacitor, (ii) cause the signal composition capacitor and the signal holding capacitor that is holding the first voltage signal to be connected in parallel for only a certain time period, (iii) after the time period has elapsed, cause the second voltage signal to be held in the signal holding capacitor, and (iv) cause the signal composition capacitor holding a voltage signal based on the first voltage signal and the signal holding capacitor holding the second voltage signal to be connected in parallel.

According to this structure, since the first and second voltage signals are successively composited using a signal composition capacitor, only one signal holding capacitor need be provided for holding the first and second voltage signals, which enables reducing the size of the pixel.

Also, the signal composition unit may cause the first voltage signal to be held in a first capacitor from among the one or more capacitors, cause the second voltage signal to be held in a second capacitor from among the one or more capacitors, and cause the first capacitor holding the first voltage signal and the second capacitor holding the second voltage signal to be connected in series.

This structure enables increasing the signal level of the composited voltage signal while making the contribution rates of the first and second voltage signals the same.

### DESCRIPTION OF THE CHARACTERS

90 imaging pixel
91 MOS transistor
92 shared vertical signal line
93 noise cancelling circuit
94 MOS transistor
95 shared signal line
96 vertical scanning circuit
97 signal output line
98 horizontal scanning circuit
99 signal output line
100 MOS solid state imaging device
101 timing generation unit
102 imaging chip
103 signal processing chip
104 mode selection unit
105 optical series

### BRIEF DESCRIPTION OF THE DRAWINGS

These and other objects, advantages, and features of the invention will become apparent from the following description thereof taken in conjunction with the accompanying drawings, which illustrate specific embodiments of the present invention.

In the drawings:

FIG. 1 is a functional block diagram showing the structure of an MOS solid state imaging device 100 pertaining to embodiment 1 of the present invention;

FIG. 2 shows the structure of an imaging pixel 90 pertaining to embodiment 1 of the present invention;

FIG. 3 is a timing chart showing driving signals for driving the imaging pixel 90 of embodiment 1, and voltage signals appearing at units of the imaging pixel 90 when being driven by the driving signals;

FIG. 4 shows a relationship between exposure time and accumulated charge in the imaging pixel 90 of embodiment 1;

FIG. 5 shows a relationship between light intensity and signal level (before composition) in the imaging pixel 90 of embodiment 1;

FIG. 6 shows a relationship between light intensity and signal level (after composition) in the imaging pixel 90 of embodiment 1;

FIG. 7 shows the structure of an imaging pixel 90 pertaining to embodiment 2 of the present invention;

FIG. 8 is a timing chart showing driving signals for driving the imaging pixel 90 of embodiment 2, and voltage signals appearing at units of the imaging pixel 90 when being driven by the driving signals;

FIG. 9 shows a relationship between exposure time and accumulated charge in the imaging pixel 90 of embodiment 2;

FIG. 10 shows the structure of an imaging pixel 90 pertaining to embodiment 3 of the present invention;

FIG. 11 shows a relationship between light intensity and signal level (after composition) in the imaging pixel 90 of embodiment 3;

FIG. 12 shows a relationship between light intensity and signal level (after composition) in an imaging pixel 90 pertaining to a modification of the present invention;

FIG. 13 shows a relationship between light intensity and signal level (after composition) in an imaging pixel 90 pertaining to another modification of the present invention;

FIG. 14 is a timing chart showing driving signals for driving an imaging pixel 90 pertaining to embodiment 4 of the present invention, and voltage signals appearing at units of the imaging pixel 90 when being driven by the driving signals;

FIG. 15 shows the structure of a camera pertaining to embodiment 4 of the present invention;

FIG. 16 shows the structure of an imaging pixel 90 pertaining to embodiment 5 of the present invention;

FIG. 17 is a timing chart showing driving signals for driving the imaging pixel 90 of embodiment 5, and voltage signals appearing at units of the imaging pixel 90 when being driven by the driving signals;

FIG. 18 shows a relationship between light intensity and signal level (after composition) in the imaging pixel 90 of embodiment 5;

FIG. 19 is a timing chart showing driving signals for driving an imaging pixel 90 pertaining to embodiment 6 of the present invention, and voltage signals appearing at units of the imaging pixel 90 when being driven by the driving signals;

FIG. 20 shows a relationship between light intensity and signal level (after composition) in the imaging pixel 90 of embodiment 6;

FIG. 21 shows the structure of an imaging pixel 90 pertaining to embodiment 7 of the present invention;

FIG. 22 is a timing chart showing driving signals for driving the imaging pixel 90 of embodiment 7, and voltage signals appearing at units of the imaging pixel 90 when being driven by the driving signals;

FIG. 23 shows the contribution rates of signal levels V1, V2 and V3 from exposure periods T1, T2 and T3 respectively;

FIG. 24 shows a relationship between light intensity and signal level (after composition) in the imaging pixel 90 of embodiment 7;

FIG. 25 shows the structure of an imaging pixel 90 pertaining to embodiment 8 of the present invention; and

FIG. 26 is a timing chart showing driving signals for driving the imaging pixel 90 of embodiment 8, and voltage signals appearing at units of the imaging pixel 90 when being driven by the driving signals.

### DESCRIPTION OF THE PREFERRED EMBODIMENTS

Embodiments of the present invention are described below with reference to the drawings.

### Embodiment 1

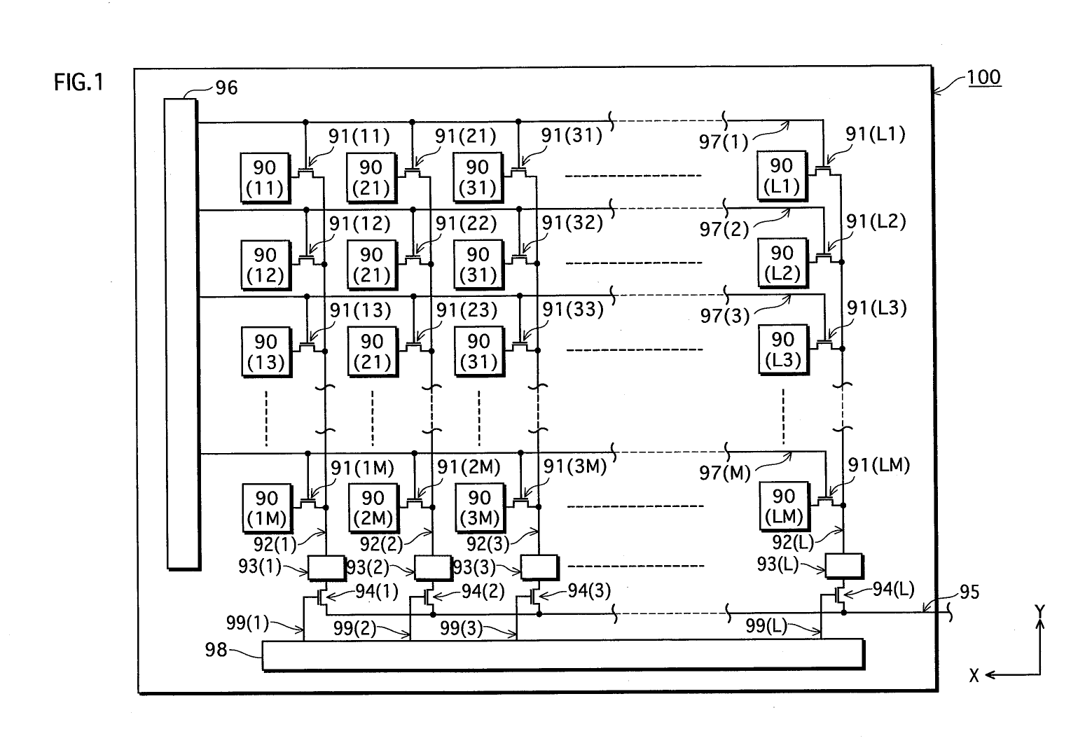

FIG. 1 is a functional block diagram showing the structure of an MOS solid state imaging device 100 pertaining to embodiment 1 of the present invention.

As shown in FIG. 1, (L×M) imaging pixels 90(11) to 90(LM) have been provided in a matrix pattern in the MOS solid state imaging device 100 of the present embodiment. The imaging pixels 90(11) to 90(LM) are respectively connected to shared vertical signal lines 92(1) to 92(L) via MOS transistors 91(11) to 91(LM).

The shared vertical signal lines 92(1) to 92(L) are connected to a shared signal line 95 via noise cancelling circuits 93(1) to 93(L) and MOS transistors 94(1) to 94(L) respectively.

In the MOS solid state imaging device 100, a vertical scanning circuit 96 and a horizontal scanning circuit 98 have been provided on a periphery of the matrix of (L×M) imaging pixels 90(11) to 90(LM). Signal output lines 97(1) to 97(M) extend out from the vertical scanning circuit 96 in the X axis direction, and are connected to gates of the MOS transistors 91(11) to 91(LM).

Signal output lines 99(1) to 99(L) extend out from the horizontal scanning circuit 98 in the Y axis direction, and are connected to gates of the MOS transistors 94(1) to 94(L).

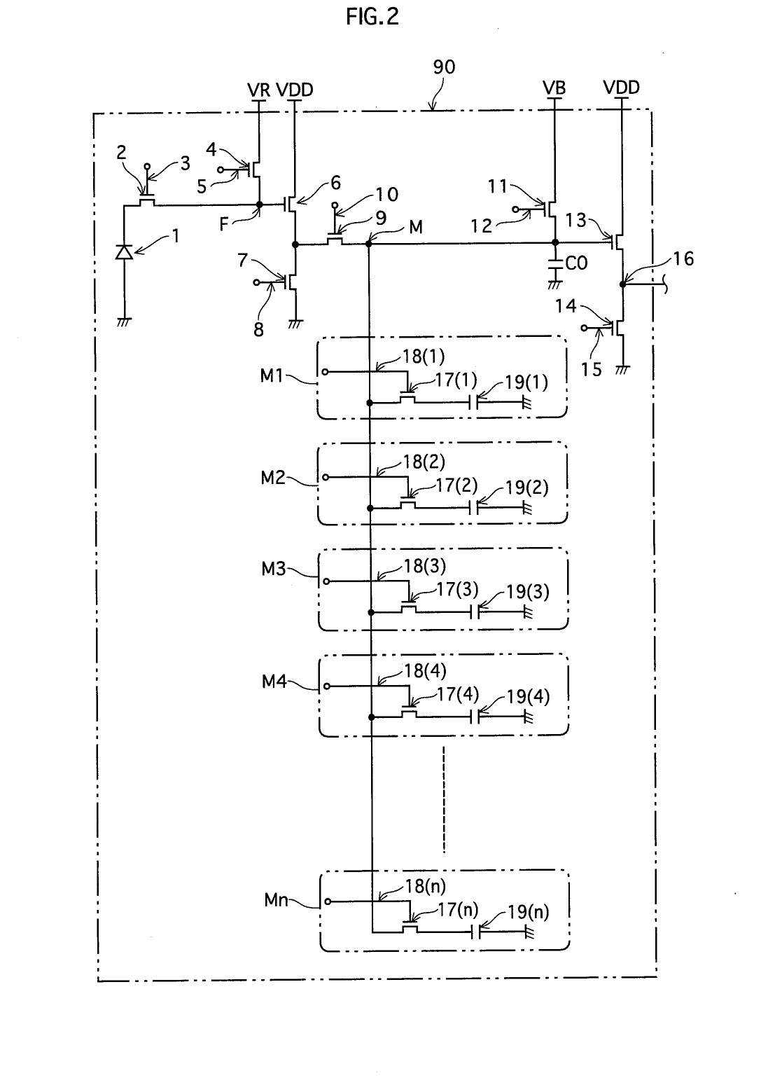

FIG. 2 shows the structure of the imaging pixel 90 of embodiment 1.

The imaging pixel 90 includes a photodiode 1, a signal generation unit and a signal composition unit.

The signal generation unit includes MOS transistors 2, 4, 6 and 7, and a floating diffusion F. The MOS transistor 2 is provided on a path connecting the photodiode 1 and the floating diffusion F. The MOS transistor 4 is provided on a path connecting the floating diffusion F and a reference voltage power supply. The MOS transistors 6 and 7 constitute a source follower. A voltage VF is supplied from the floating diffusion F to the gate of the MOS transistor 6, and a power supply voltage VDD is supplied to the drain of the MOS transistor 6. A bias voltage is supplied to the gate of the MOS transistor 7, and a ground voltage is supplied to the source of the MOS transistor 7. The source follower constituted by the MOS transistors 6 and 7 outputs a voltage signal resulting from multiplication of the voltage VF from the floating diffusion F by the gain.

The signal composition unit includes MOS transistors 9, 11, 13 and 14, memories M1 to Mn, and a signal composition capacitor C0. The MOS transistor 9 is provided on a path connecting the drain of the MOS transistor 7 and point M. The MOS transistor 11 is provided on a path connecting point M and the reference voltage power supply. The MOS transistors 13 and 14 constitute a source follower. The power supply voltage VDD is supplied to the drain of the MOS transistor 13, and a voltage VM is supplied from point M to the gate of the MOS transistor 13. A bias voltage is supplied to the gate of the MOS transistor 14, and a ground voltage is supplied to the source of the MOS transistor 14. The source follower constituted by the MOS transistors 13 and 14 outputs a voltage V16, which is the voltage VM at point M multiplied by the gain. The memory M1 includes a capacitor 19(1) and an MOS transistor 17(1). The MOS transistor 17(1) is provided on a path connecting the capacitor 19(1) and point M. The memories M2 to Mn have the same structure as the memory M1, and the capacitances of the capacitors 19(1) to 19(n) are the same. The signal composition capacitor C0 holds a floating capacitance.

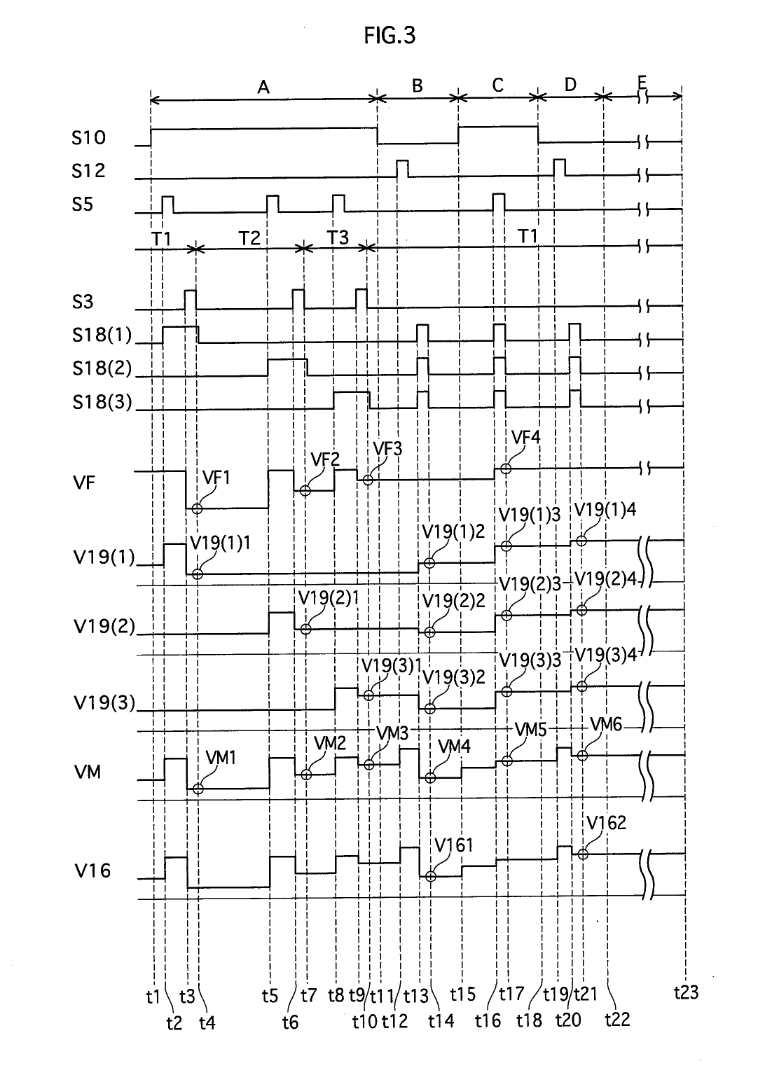

FIG. 3 is a timing chart showing driving signals for driving the imaging pixel 90 of embodiment 1, and voltage signals appearing at units of the imaging pixel 90 when being driven by the driving signals.

In FIG. 3, period A is a period during which read voltage signals are held in the memories, period B is a period during which the read voltage signals held in the memories are output, period C is a period during which reset voltage signals are held in the memories, and period D is a period during which the reset voltage signals held in the memories are output.

A driving signal S10 is a signal supplied to a gate 10 of the MOS transistor 9, a driving signal S12 is a signal supplied to a gate 12 of the MOS transistor 11, a driving signal 5 is a signal supplied to a gate 5 of the MOS transistor 4, a driving signal S3 is a signal supplied to a gate 3 of the MOS transistor 2, a driving signal S18(1) is a signal supplied to a gate 18(1) of the MOS transistor 17(1), a driving signal S18(2) is a signal supplied to a gate 18(2) of the MOS transistor 17(2), and a driving signal S18(3) is a signal supplied to a gate 18(3) of the MOS transistor 17(3).

A voltage signal VF is a signal that appears at the floating diffusion F, a voltage signal V19(1) is a signal that appears at the capacitor 19(1), a voltage signal V19(2) is a signal that appears at the capacitor 19(2), a voltage signal V19(3) is a signal that appears at the capacitor 19(3), a voltage signal VM is a signal that appears at point M, and a voltage signal V16 is a signal that appears at the output node of the source follower constituted by the MOS transistors 13 and 14.

At time t2, the MOS transistor 2 is in an OFF state, and the MOS transistor 4 is turned to an ON state for a predetermined time period. As a result, the voltage VF of the floating diffusion F is brought to a reference level VR.

From time t3 to time t4, the MOS transistor 4 remains in an OFF state, and the MOS transistor 2 is in an ON state. As a result, a charge generated by the photodiode 1 during exposure period T1 is transferred to the floating diffusion F. This causes the voltage VF of the floating diffusion F to fall from the reference level VR by an amount that corresponds to the amount of charge generated during the exposure period T1, that is to say, the voltage VF falls to a read level VF1. At this time, the MOS transistors 11, 17(2) and 17(3) are in an OFF state, and the MOS transistors 9 and 17(1) are in an ON state. Therefore, the voltage VM at point M is brought to level VM1, which is the read level VF1 multiplied by the gain of the source follower, and the voltage V19(1) of the capacitor 19(1) is brought to level V19(1)1, which is substantially the same as level VM1. When the MOS transistor 17-(1) is turned to an OFF state after time t4, the voltage V19(1) of the capacitor 19(1) is held at level V19(1)1.

Then at time t5, the MOS transistor 2 is in an OFF state, and the MOS transistor 4 is turned to an ON state for a predetermined time period. As a result, the voltage VF of the floating diffusion is brought to the reference level VR.

From time t6 to time t7, the MOS transistor 4 remains in an OFF state, and the MOS transistor 2 is in an ON state. As a result, a charge generated by the photodiode 1 during exposure period T2 is transferred to the floating diffusion F. This causes the voltage VF of the floating diffusion F to fall from the reference level VR by an amount that corresponds to the amount of charge generated during the exposure period T2, that is to say, the voltage VF falls to a read level VF2. At this time, the MOS transistors 11, 17(1) and 17(3) are in an OFF state, and the MOS transistors 9 and 17(2) are in an ON state. Therefore, the voltage VM at point M is brought to level VM2, which is the read level VF2 multiplied by the gain of the source follower, and the voltage V19(2) of the capacitor 19(2) is brought to level V19(2)1, which is substantially the same as level VM2. When the MOS transistor 17(2) is turned to an OFF state after time t7, the voltage V19(2) of the capacitor 19(2) is held at level V19(2)1.

Then at time t8, the MOS transistor 2 is in an OFF state, and the MOS transistor 4 is turned to an ON state for a predetermined time period. As a result, the voltage VF of the floating diffusion is brought to the reference level VR.

From time t9 to time t10, the MOS transistor 4 remains in an OFF state, and the MOS transistor 2 is in an ON state. As a result, a charge generated by the photodiode 1 during exposure period T3 is transferred to the floating diffusion F. This causes the voltage VF of the floating diffusion F to fall from the reference level VR by an amount that corresponds to the amount of charge generated during the exposure period T3, that is to say, the voltage VF falls to a read level VF3. At this time, the MOS transistors 11, 17(1) and 17(2) are in an OFF state, and the MOS transistors 9 and 17(3) are in an ON state. Therefore, the voltage VM at point M is brought to level VM3, which is the read level VF3 multiplied by the gain of the source follower, and the voltage V19(3) of the capacitor 19(3) is brought to level V19(3)1, which is substantially the same as level VM3. When the MOS transistor 17(3) is turned to an OFF state after time t10, the voltage V19(3) of the capacitor 19(3) is held at level V19(3)1.

At time t12, the MOS transistor 9 is in an OFF state, and the MOS transistor 11 is turned to an ON state for a predetermined time period. As a result, the voltage VM at point M is brought to a reference level VB.

From time t13 to time t14, the MOS transistors 9 and 11 remain in an OFF state, and the MOS transistors 17(1), 17(2) and 17(3) are in an ON state. At this time, the capacitors 19(1), 19(2), 19(3), and C0 become connected in parallel. As a result, the voltage VM at point M is brought to voltage VM4, which is an average of levels V19(1)1, V19(2)1, V19(3)1, and VB.

Then from time t16 to time t17 the MOS transistor 2 remains in an OFF state, and the MOS transistor 4 is in an ON state. As a result, the voltage VF of the floating diffusion F is brought to the reference level VR. At this time, the MOS transistor 11 is in an OFF state, and the MOS transistors 9, 17(1), 17(2) and 17(3) are in an ON state. Therefore, the voltage VM at point M is brought to level VM5, which is the reference level VR multiplied by the gain of the source follower. Also, the voltage V19(1) of the capacitor 19(1), the voltage V19(2) of the capacitor 19(2), and the voltage V19(3) of the capacitor 19(3) are brought to levels V19(1)3, V19(2)3, and V19(3)3 respectively, each of which is substantially the same as level VM5. When the MOS transistors 17(1), 17(2) and 17(3) are turned to an OFF state after time T17, the voltages of the capacitors 19(1), 19(2) and 19(3) are held at levels V19(1)3, V19(2)3, and V19(3)3 respectively.

Then at time t19, the MOS transistor 9 is in an OFF state, and the MOS transistor 11 is turned to an ON state for a predetermined time period. As a result, the voltage VM at point M is brought to the reference level VB.

From time t20 to time t21, the MOS transistors 9 and 11 remain in an OFF state, and the MOS transistors 17(1), 17(2) and 17(3) are in an ON state. At this time, the capacitors 19(1), 19(2), 19(3), and C0 become connected in parallel. As a result, the voltage VM at point M is brought to voltage VM6, which is an average of levels V19(1)3, V19(2)3, V19(3)3, and VB.

The source follower constituted by the MOS transistors 13 and 14 outputs the voltage V16, which is the voltage VM at point M multiplied by the gain. The voltage V16 is sampled by the noise cancelling circuit 93 at time t16 and time t21. The noise cancelling circuit 93 obtains a pixel signal by calculating a difference between level V161 at time t16 and level V162 at time t21.

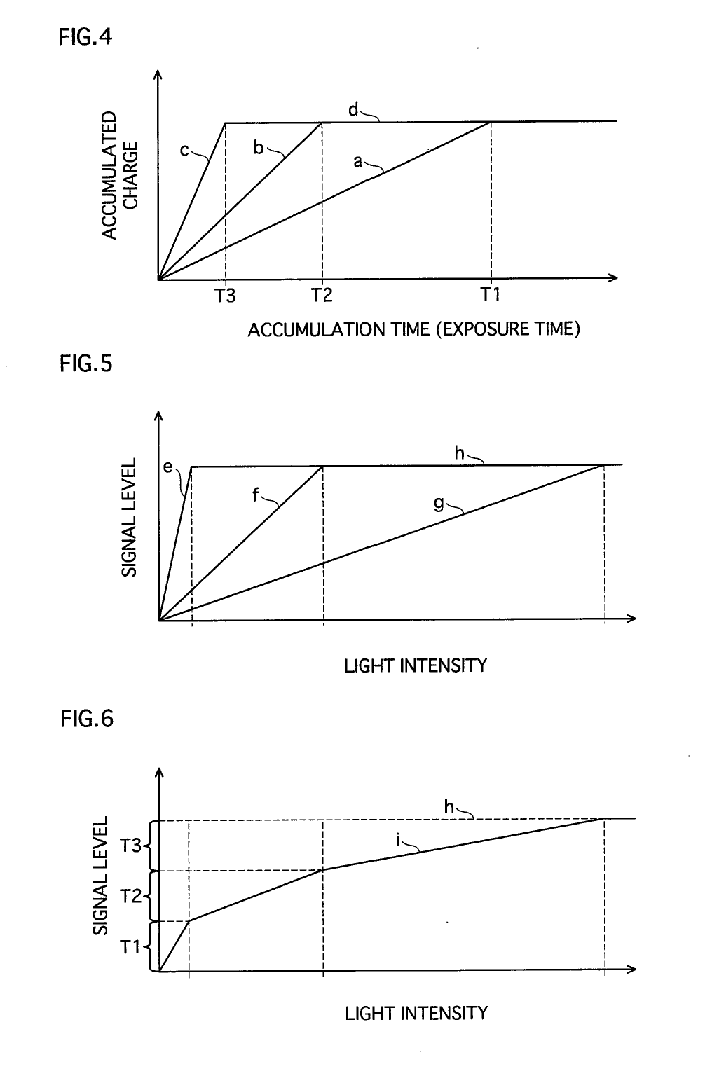

FIG. 4 shows a relationship between exposure time and accumulated charge in the image pixel 90 of embodiment 1.

An upper limit d of the accumulated charge in the image pixel 90 is determined by the capacitance of the floating diffusion F or the photodiode 1. The slope of line a indicates an upper limit of light intensity at which the charge does not reach saturation during exposure period T1. Similarly, the slopes of lines b and c indicate the upper limits of light intensity at which the charge does not reach saturation during exposure periods T2 and T3 respectively. As can be seen in FIG. 4, the shorter the exposure period, the less readily the charge reaches saturation even when the light intensity is strong.

FIG. 5 shows a relationship between light intensity and signal level (before composition) in the image pixel 90 of embodiment 1.

An upper limit h of the signal level in the image pixel 90 is determined in correspondence with the upper limit d of the accumulated charge. Line e indicates signal level with respect to light intensity in the case of exposure period T1. Similarly, lines f and g indicate signal level with respect to light intensity in the cases of exposure periods T2 and T3 respectively. As can be seen in FIG. 5, the shorter the exposure period, the less readily the signal level reaches saturation even when the light intensity is strong.

FIG. 6 shows a relationship between light intensity and signal level (after composition) in the image pixel 90 of embodiment 1.

A bent line i indicates signal level with respect to light intensity in the case of compositing the signal levels of exposure periods T1, T2 and T3. As can be seen in FIG. 6, compositing the signal levels of different exposure periods enables ensuring a sufficient signal level even when the light intensity is weak, while preventing the signal level from reaching saturation even when the light intensity is strong. This means that the dynamic range is increased. Note that in embodiment 1, the capacitors 19(1) to 19(n) all have the same capacitance. The signal levels in exposure periods T1, T2 and T3 therefore all have the same contribution rate in the composited signal level.

In the structure pertaining to embodiment 1 of the present invention, pixel signals in exposure periods T1, T2 and T3 are output from the source follower and held in the capacitors 19. Therefore, variations do not occur in the voltage levels of the held pixel signals even if there are variations between the capacitances of the capacitors 19. In other words, it is possible to prevent the occurrence of fixed pattern noise that originates from variations in the capacitances of capacitors. In addition to the effect of increasing the dynamic range, this has the superior effect of suppressing image roughness so as to obtain a high-quality image.

### Embodiment 2

Embodiment 2 describes an AMI (Amplified MOS Imager) solid state imaging device.

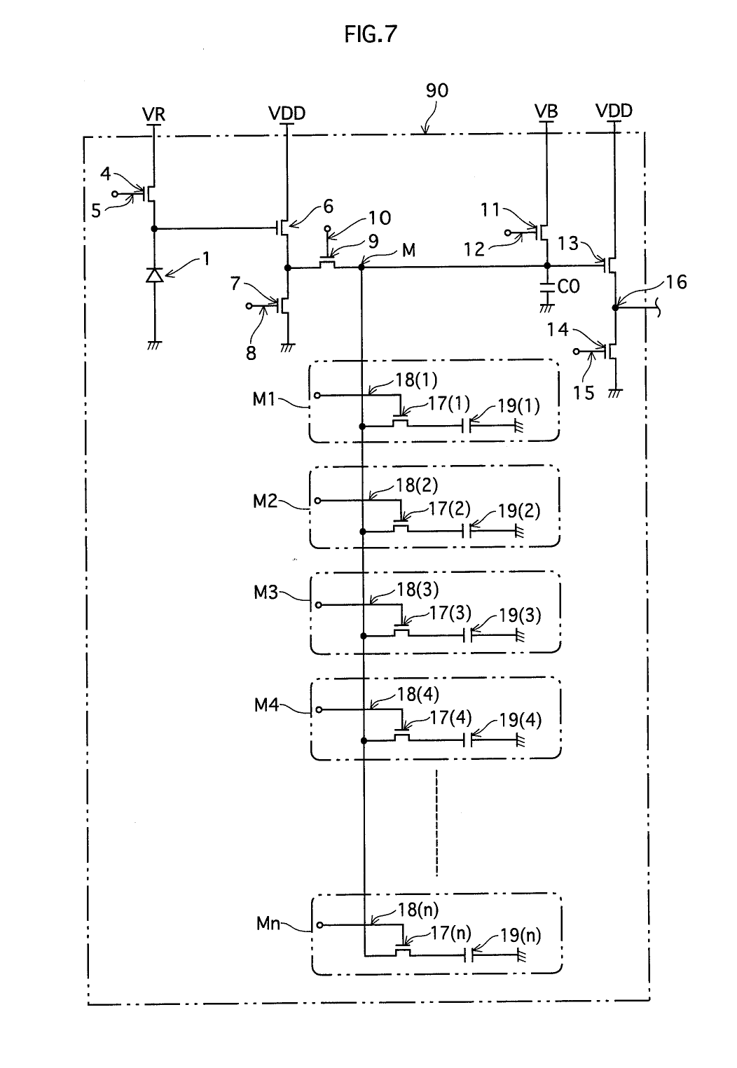

FIG. 7 shows the structure of an image pixel 90 pertaining to embodiment 2 of the present invention.

The image pixel 90 includes a photodiode 1, a signal generation unit and a signal composition unit. A description of the structure of the signal composition unit has been omitted due to being the same as in embodiment 1.

The signal generation unit includes MOS transistors 4, 6 and 7. The MOS transistor 4 is provided on a path connecting the photodiode 1 and a reference voltage power supply. The MOS transistors 6 and 7 constitute a source follower. A voltage V1 is supplied from the photodiode 1 to the gate of the MOS transistor 6, and a power supply voltage VDD is supplied to the drain of the MOS transistor 6. A bias voltage is supplied to the gate of the MOS transistor 7, and a ground voltage is supplied to the source of the MOS transistor 7. The source follower constituted by the MOS transistors 6 and 7 outputs a voltage signal that corresponds to the voltage V1 at the photodiode 1.

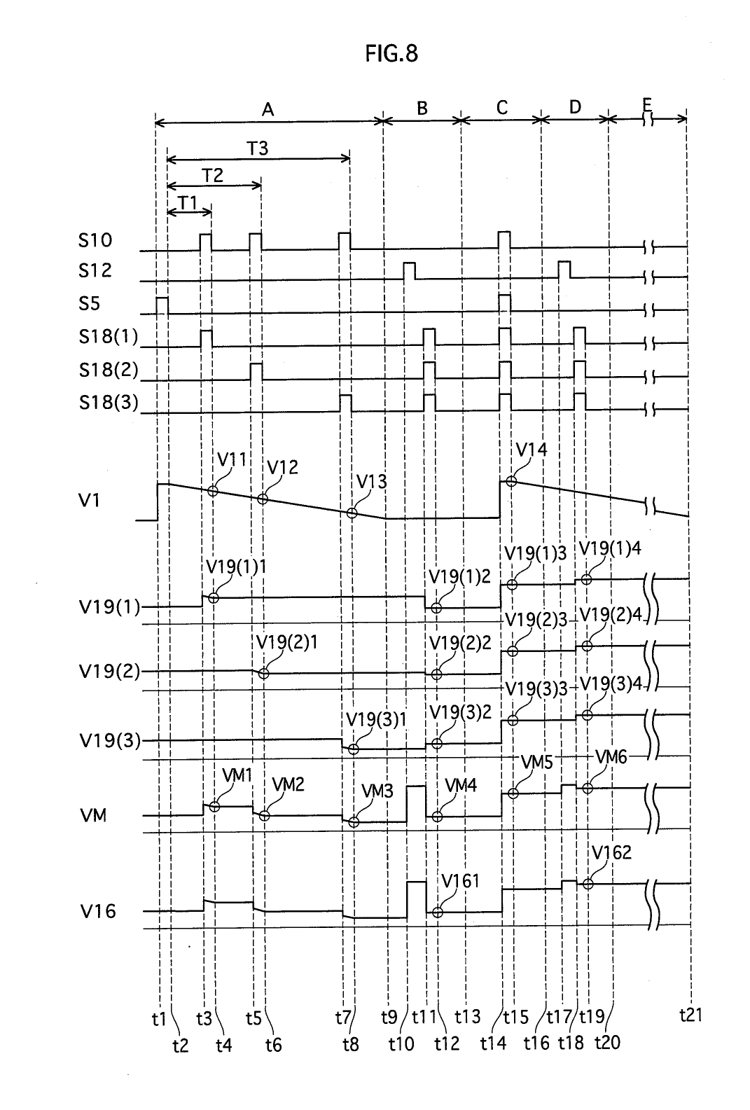

FIG. 8 is a timing chart showing driving signals for driving the imaging pixel 90 of embodiment 2, and voltage signals appearing at units of the imaging pixel 90 when being driven by the driving signals.

In FIG. 8, period A is a period during which read voltage signals are held in the memories, period B is a period during which the read voltage signals held in the memories are output, period C is a period during which reset voltage signals are held in the memories, and period D is a period during which the reset voltage signals held in the memories are output.

A driving signal S10 is a signal supplied to a gate 10 of the MOS transistor 9, a driving signal S12 is a signal supplied to a gate 12 of the MOS transistor 11, a driving signal 5 is a signal supplied to a gate 5 of the MOS transistor 4, a driving signal S18(1) is a signal supplied to a gate 18(1) of the MOS transistor 17(1), a driving signal S18(2) is a signal supplied to a gate 18(2) of the MOS transistor 17(2), and a driving signal S18(3) is a signal supplied to a gate 18(3) of the MOS transistor 17(3).

A voltage signal V1 is a signal that appears at the photodiode 1, a voltage signal V19(1) is a signal that appears at the capacitor 19(1), a voltage signal V19(2) is a signal that appears at the capacitor 19(2), a voltage signal V19(3) is a signal that appears at the capacitor 19(3), a voltage signal VM is a signal that appears at point M, and a voltage signal V16 is a signal that appears at the output node of the source follower constituted by the MOS transistors 13 and 14.

At time t2, the MOS transistor 4 is turned to an ON state for a predetermined time period. As a result, the voltage V1 of the photodiode 1 is brought to a reference level VR.

From time t3 to time t4, the MOS transistor 11 remains in an OFF state, and the MOS transistors 9 and 17(1) are in an ON state. This causes the voltage V1 of the photodiode 1 to fall from the reference level VR by an amount that corresponds to the amount of charge generated during the exposure period T1, that is to say, the voltage V1 falls to a read level V11. At this time, the voltage VM at point M is brought to level VM1, which is the read level V11 multiplied by the gain of the source follower, and the voltage V19(1) of the capacitor 19(1) is brought to level V19(1)1, which is substantially the same as level VM1. When the MOS transistor 17(1) is turned to an OFF state after time t4, the voltage V19(1) of the capacitor 19(1) is held at level V19(1)1.

From time t5 to time t6, the MOS transistor 11 remains in an OFF state, and the MOS transistors 9 and 17(2) are in an ON state. This causes the voltage V1 of the photodiode 1 to fall from the reference level VR by an amount that corresponds to the amount of charge generated during the exposure period T2, that is to say, the voltage V1 falls to a read level V12. At this time, the voltage VM at point M is brought to level VM2, which is the read level V12 multiplied by the gain of the source follower, and the voltage V19(2) of the capacitor 19(2) is brought to level V19(2)1, which is substantially the same as level VM2. When the MOS transistor 17(2) is turned to an OFF state after time t6, the voltage V19(2) of the capacitor 19(2) is held at level V19(2)1.

From time t7 to time t8, the MOS transistor 11 remains in an OFF state, and the MOS transistors 9 and 17(3) are in an ON state. This causes the voltage V1 of the photodiode 1 to fall from the reference level VR by an amount that corresponds to the amount of charge generated during the exposure period T3, that is to say, the voltage V1 falls to a read level V13. At this time, the voltage VM at point M is brought to level VM3, which is the read level V13 multiplied by the gain of the source follower, and the voltage V19(3) of the capacitor 19(3) is brought to level V19(3)1, which is substantially the same as level VM3. When the MOS transistor 17(3) is turned to an OFF state after time t8, the voltage V19(3) of the capacitor 19(3) is held at level V19(3)1.

At time t10, the MOS transistor 9 is in an OFF state, and the MOS transistor 11 is turned to an ON state for a predetermined time period. As a result, the voltage VM at point M is brought to a reference level VB.

From time t11 to time t12, the MOS transistors 9 and 11 remain in an OFF state, and the MOS transistors 17(1), 17(2) and 17(3) are in an ON state. At this time, the capacitors 19(1), 19(2), 19(3), and C0 become connected in parallel. As a result, the voltage VM at point M is brought to voltage VM4, which is an average of levels V19(1)1, V19(2)1, V19(3)1, and VB.

Then from time t14 to time t15 the MOS transistor 11 remains in an OFF state, and the MOS transistors 4 and 9 are in an ON state. As a result, the voltage V1 of the photodiode 1 is brought to the reference level VR. Furthermore, the voltage VM at point M is brought to level VM5, which is the reference level VR multiplied by the gain of the source follower. Also, the voltage V19(1) of the capacitor 19(1), the voltage V19(2) of the capacitor 19(2), and the voltage V19(3) of the capacitor 19(3) are brought to levels V19(1)3, V19(2)3, and V19(3)3 respectively, each of which is substantially the same as level VM5. When the MOS transistors 17(1), 17(2) and 17(3) are turned to an OFF state after time T15, the voltages of the capacitors 19(1), 19(2) and 19(3) are held at levels V19(1)3, V19(2)3, and V19(3)3 respectively.

Then at time t17, the MOS transistor 9 is in an OFF state, and the MOS transistor 11 is turned to an ON state for a predetermined time period. As a result, the voltage VM at point M is brought to the reference level VB.

From time t18 to time t19, the MOS transistors 9 and 11 remain in an OFF state, and the MOS transistors 17(1), 17(2) and 17(3) are in an ON state. At this time, the capacitors 19(1), 19(2), 19(3), and C0 become connected in parallel. As a result, the voltage VM at point M is brought to voltage VM6, which is an average of levels V19(1)3, V19(2)3, V19(3)3, and VB.

The noise cancelling circuit 93 obtains a pixel signal by calculating a difference between level V161 at time t12 and level V162 at time t19.

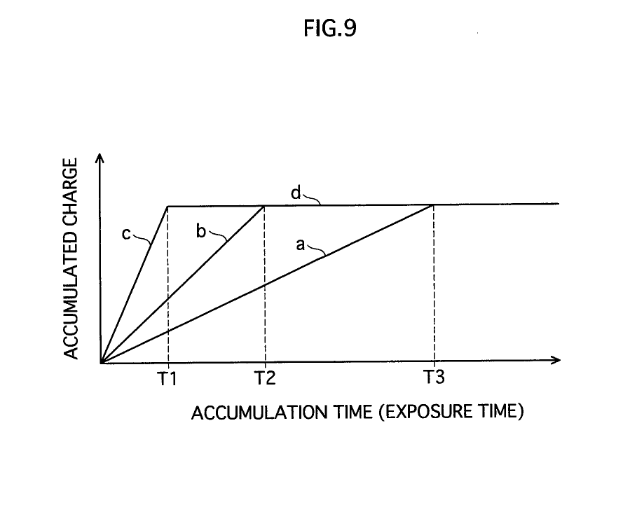

FIG. 9 shows a relationship between exposure time and accumulated charge in the image pixel 90 of embodiment 2.

An upper limit d of the accumulated charge in the image pixel 90 is determined by the capacitance of the photodiode 1. The slope of line a indicates an upper limit of light intensity at which the charge does not reach saturation during exposure period T3. Similarly, the slopes of lines b and c indicate the upper limits of light intensity at which the charge does not reach saturation during exposure period T2 and T1 respectively. In embodiment 1, the exposure periods T1, T2 and T3 are progressively shorter in the stated order. In embodiment 2, however, the lengths of the exposure periods T1, T2 and T3 are progressively longer in the stated order. A relationship between the lines a, b and c and the exposure periods T1, T2 and T3 is different between embodiments 1 and 2. However, it is true in both embodiments 1 and 2 that the shorter the exposure period, the less readily the charge reaches saturation even when the light intensity is strong.

### Embodiment 3

In embodiment 3, the capacitance of the capacitor 19(1) in the memory M1 is different from the capacitances of the capacitors 19(2) to 19(n) in the memories M2 to Mn. A description of other aspects has been omitted due to being the same as in embodiment 1.

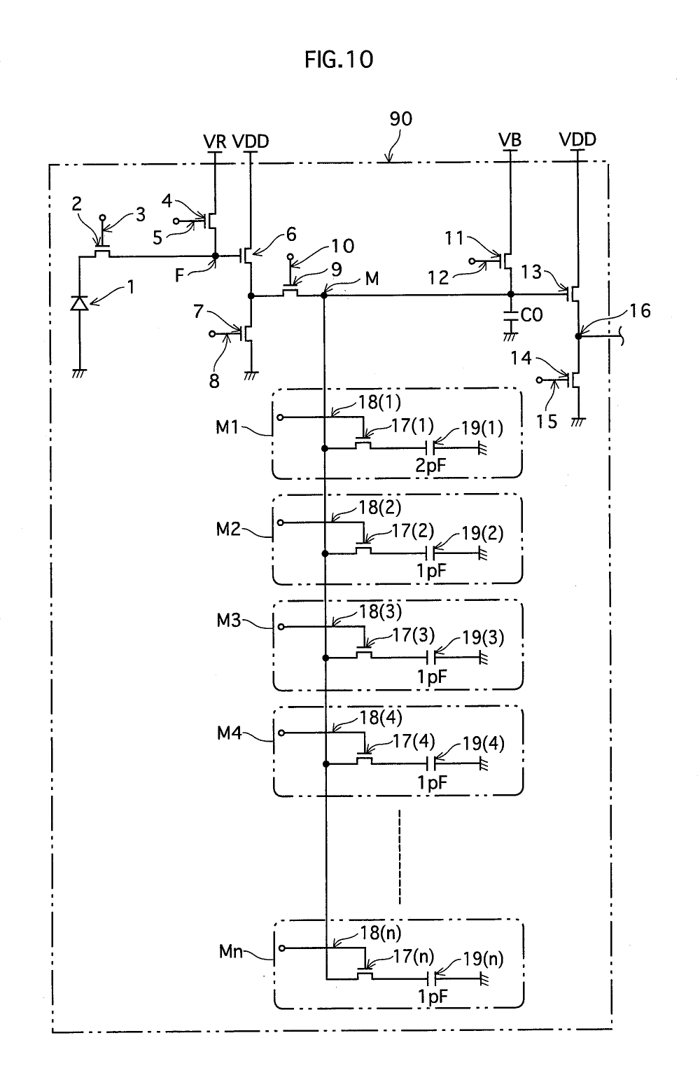

FIG. 10 shows the structure of an image pixel 90 pertaining to embodiment 3 of the present invention.

The capacitor 19(1) of the memory M2 has a capacitance of 2 pF, and the capacitors 19(2) to 19(n) of the memories M2 to Mn each have a capacitance of 1 pF. Since the capacitance of the capacitor 19(1) is larger than the capacitance of the capacitors 19(2) to 19(n), when compositing the voltage signals corresponding to the exposure periods T1, T2 and T3, the contribution rate of the voltage signal corresponding to the exposure period T1 is larger than the contribution rate of the voltage signals corresponding to the exposure periods T2 and T3.

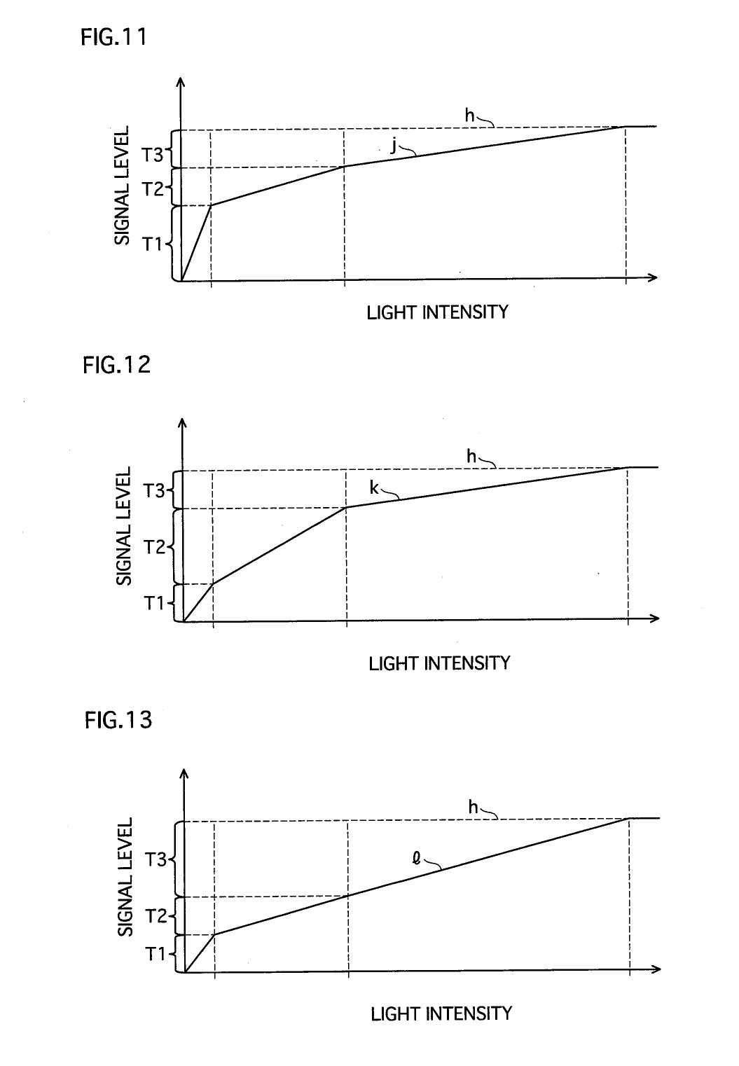

FIG. 11 shows a relationship between light intensity and signal level (after composition) in the image pixel 90 of embodiment 3.

A bent line j indicates signal level with respect to light intensity in the case of compositing the signals levels of exposure periods T1, T2 and T3. In embodiment 3, the capacitance ratio of the capacitors 19(1), 19(2) and 19(3) is 2:1:1. The contribution rates of the signal levels of exposure periods T1, T2 and T3 in the composited signal level are therefore in a ratio 2:1:1. This enables increasing the contrast in the region of low light intensity (low luminance range).

Note that if the capacitance ratio of the capacitors 19(1), 19(2) and 19(3) is made 1:2:1, the contribution rates of the signal levels of exposure periods T1, T2 and T3 in the composited signal level are in a ratio of 1:2:1 (see FIG. 12). This enables increasing the contrast in the mid luminance range. Also, if the capacitance ratio of the capacitors 19(1), 19(2) and 19(3) is made 1:1:2, the contribution rates of the signal levels of exposure periods T1, T2 and T3 in the composited signal level are in a ratio of 1:1:2 (see FIG. 13). This enables increasing the contrast in the high luminance range.

### Embodiment 4

In embodiment 4, the number of capacitors that hold voltage signals corresponding to the exposure period T1 is different from the number of capacitors that hold voltage signals corresponding to the exposure periods T2 and T3. A description of other aspects has been omitted due to being the same as in embodiment 1.

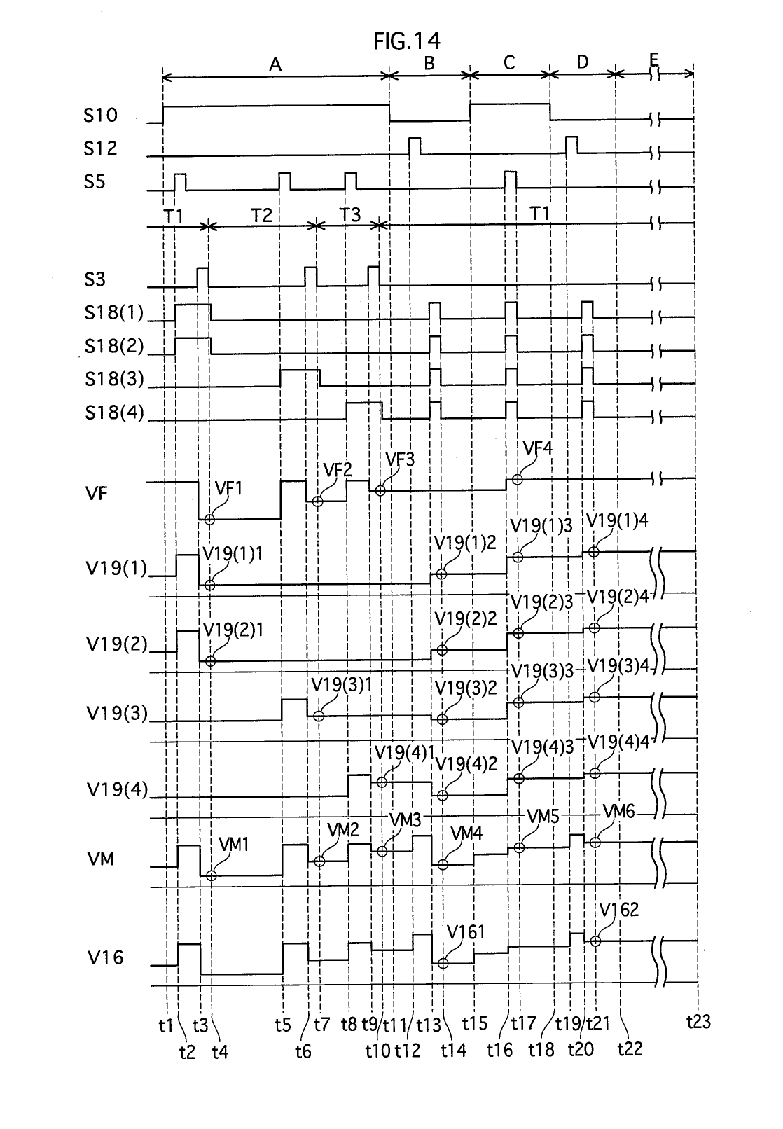

FIG. 14 is a timing chart showing driving signals for driving an imaging pixel 90 pertaining to embodiment 4 of the present invention, and voltage signals appearing at units of the imaging pixel 90 when being driven by the driving signals.

A driving signal S18(1) is a signal supplied to a gate 18(1) of an MOS transistor 17(1), a driving signal S18(2) is a signal supplied to a gate 18(2) of an MOS transistor 17(2), a driving signal S18(3) is a signal supplied to a gate 18(3) of an MOS transistor 17(3), and a driving signal S18(4) is a signal supplied to a gate 18(4) of an MOS transistor 17(4).

A voltage signal V19(1) is a signal that appears at a capacitor 19(1), a voltage signal V19(2) is a signal that appears at a capacitor 19(2), a voltage signal V19(3) is a signal that appears at a capacitor 19(3), and a voltage signal V19(4) is a signal that appears at a capacitor 19(4).

In embodiment 4, signal levels of the exposure period T1 are held in the capacitors 19(1) and 19(2), signal levels of the exposure period T2 are held in the capacitor 19(3), and signal levels of the exposure period T3 are held in the capacitor 19(4). Since the ratio of the number of capacitors that hold the signal levels of the exposure periods T1, T2 and T3 is 2:1:1, the contribution rates of the signal levels of the exposure periods T1, T2 and T3 in the composited signal level are in a ratio of 2:1:1 (see FIG. 11).

Note that if the ratio of the number of capacitors corresponding to the exposure periods T1, T2 and T3 is 1:2:1, the contribution rates of the signal levels of the exposure periods T1, T2 and T3 in the composited signal level are in a ratio of 1:2:1 (see FIG. 12). Also, if the ratio of the number of capacitors corresponding to the exposure periods T1, T2 and T3 is 1:1:2, the contribution rate of the signal levels of the exposure periods T1, T2 and T3 in the composited signal level is 1:1:2 (see FIG. 13).

Depending on the use of the solid state imaging device, there are cases in which it is desirable to dynamically change, according to imaging conditions, the luminance range for which to increase contrast. Examples include increasing the contrast of the high luminance range in high luminance imaging mode, and increasing the contrast of the low luminance range in low luminance imaging mode. In the case of the high luminance imaging mode, the driving signals S18(1) to S18(4) may be supplied such that the ratio of the number of capacitors corresponding to the exposure periods T1, T2 and T3 is 2:1:1. In the case of the low luminance imaging mode the driving signals S18(1) to S18(4) may be supplied such that the ratio of the number of capacitors corresponding to the exposure periods T1, T2 and T3 is 1:1:2. The following describes a structure for dynamically changing, in accordance with imaging conditions, the luminance range for which contrast is raised.

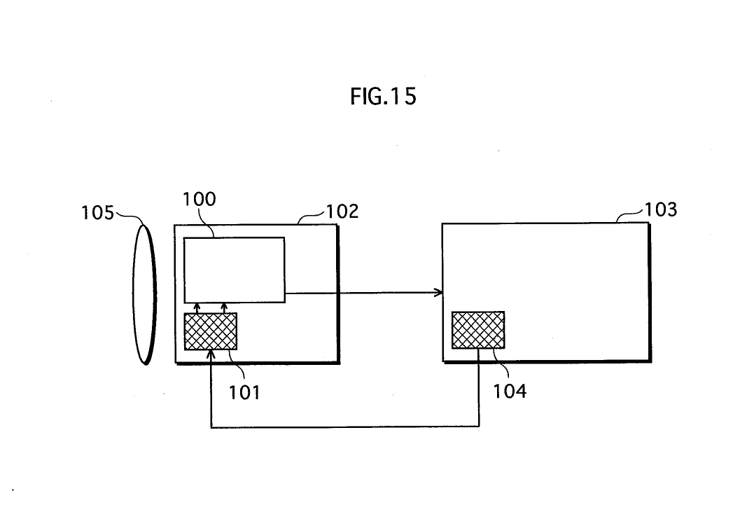

FIG. 15 shows the structure of a camera pertaining to embodiment 4 of the present invention.

The camera includes an imaging chip 102, a signal processing chip 103, and an optical series 105. An MOS solid state imaging device 100 and a timing generation unit 101 have been mounted on the imaging chip 102. A mode selection unit 104 has been mounted on the signal processing chip 103. The timing generation unit 101 generates driving signals in accordance with a mode selected by the mode selection unit 104. The generated driving signals are supplied to the MOS solid state imaging device 100. This structure enables dynamically changing, in accordance with imaging conditions, the luminance range for which contrast is to be increased.

### Embodiment 5

Embodiment 5 describes an MOS solid state imaging device that successively composites signal levels from the exposure periods T1, T2 and T3.

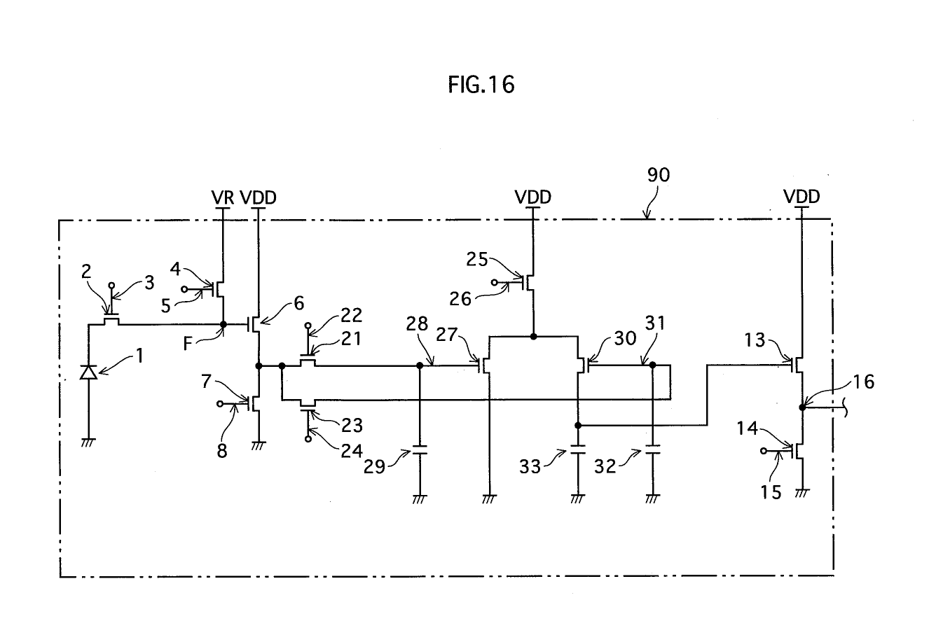

FIG. 16 shows the structure of an imaging pixel 90 pertaining to embodiment 5 of the present invention.

The structure of the signal composition unit in embodiment 5 is different from embodiment 1. A description of other structures has been omitted due to being the same as in embodiment 1.

In the present embodiment, the signal composition unit includes MOS transistors 13, 14, 21, 23, 25, 27 and 30, and capacitors 29, 32 and 33. A bias voltage is supplied to a gate 26 of the MOS transistor 25, and a power supply voltage VDD is supplied to the drain of the MOS transistor 25. The drains of the MOS transistors 27 and 30 are both connected to the source of the MOS transistor 25, the source of the MOS transistor 27 is connected to a ground, and the source of the MOS transistor 30 is connected to the capacitor 33. The MOS transistors 25, 27 and 30 constitute a differential amplifier circuit. The MOS transistor 21 is provided on a path connecting the output node of a source follower constituted from MOS transistors 6 and 7, and a gate 28 of the MOS transistor 27. The MOS transistor 23 is provided on a path connecting the output node of the source follower constituted from the MOS transistors 6 and 7, and a gate 31 of the MOS transistor 30. The capacitor 33 is provided on a path connecting the source of the MOS transistor 30 and a ground. The MOS transistors 13 and 14 constitute a source follower. The power supply voltage VDD is supplied to the drain of the MOS transistor 13, and a voltage V33 is supplied from the capacitor 33 to the gate of the MOS transistor 13. The bias voltage is supplied to the gate of the MOS transistor 14, and a ground voltage is supplied to the source of the MOS transistor 14. The source follower constituted by the MOS transistors 13 and 14 outputs a voltage V16, which is the voltage V33 of the capacitor 33 multiplied by the gain. The capacitors 29 and 32 both hold a floating capacitance.

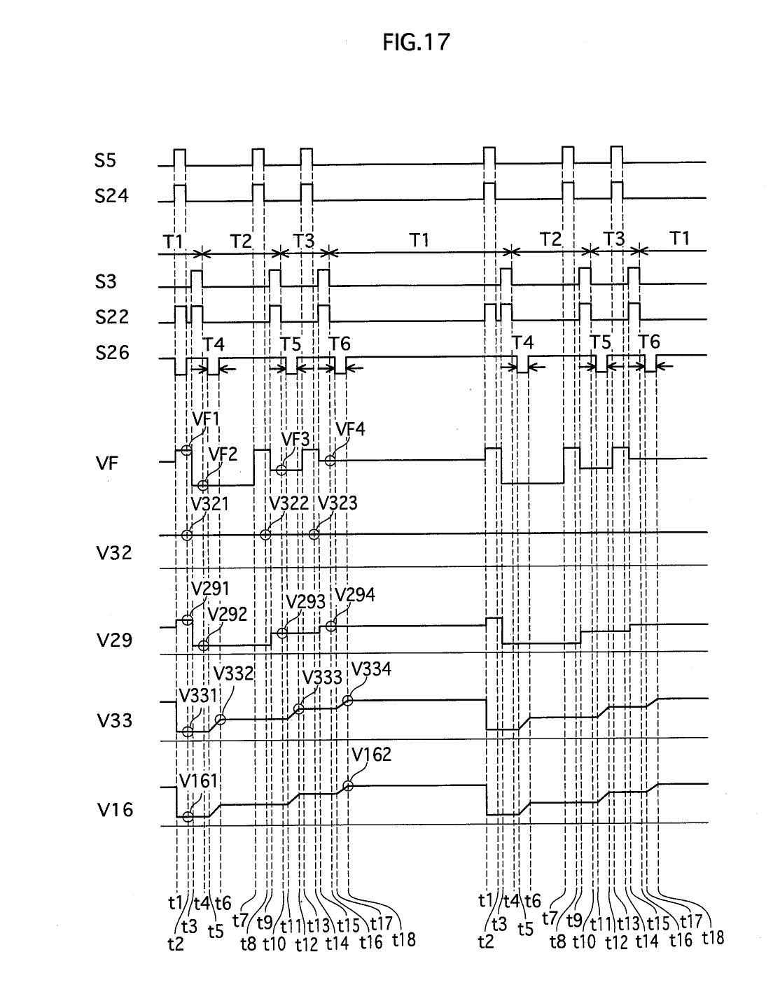

FIG. 17 is a timing chart showing driving signals for driving the imaging pixel 90 of embodiment 5, and voltage signals appearing at units of the imaging pixel 90 when being driven by the driving signals.

A driving signal S5 is a signal supplied to the gate 5 of an MOS transistor 4, a driving signal S24 is a signal supplied to the gate 24 of the MOS transistor 23, a driving signal S3 is a signal supplied to the gate 3 of an MOS transistor 2, a driving signal S22 is a signal supplied to the gate 22 of the MOS transistor 21, and a driving signal S26 is a signal supplied to the gate 26 of the MOS transistor 25.

A voltage signal VF is a signal appearing at a floating diffusion F, a voltage signal V32 is a signal appearing at the capacitor 32, a voltage signal V29 is a signal appearing at the capacitor 29, a voltage signal V33 is a signal appearing at the capacitor 33, and a voltage signal V16 is a signal appearing at the output node of the source follower constituted by the MOS transistors 13 and 14.

From time t1 to time t2, the MOS transistor 2 remains in an OFF state, and the MOS transistors 4, 21, 23 and 25 are in an ON state. As a result, the voltage VF of the floating diffusion F is brought to a reference level VR. A voltage V29 of the capacitor 29 and a voltage V32 of the capacitor 32 are brought to levels V291 and V321 respectively, which are the reference level VR multiplied by the gain of the source follower. Since the levels V291 and V321 are supplied to the gates of the MOS transistors 27 and 30 respectively, both of the MOS transistors 27 and 30 are turned to an ON state. As a result, the voltage V33 of the capacitor 33 is brought to an initial level V331. When the MOS transistors 21 and 23 are turned to an OFF state after time t2, the voltages V29 and V32 of the capacitors 29 and 32 are held at the levels V291 and V321.

From time t3 to time t4, the MOS transistors 4, 23 and 25 remain in an OFF state, and the MOS transistors 2 and 21 are in an ON state. As a result, a charge generated by the photodiode 1 during exposure period T1 is transferred to the floating diffusion F. This causes the voltage VF of the floating diffusion F to fall from the reference level VR by an amount that corresponds to the amount of charge generated during the exposure period T1, that is to say, the voltage VF falls to a read level VF2. At this time, the MOS transistor 21 is in an ON state. As a result, the voltage V29 of the capacitor 29 is brought to a level V292, which is the read level VF2 multiplied by the gain of the source follower. When the MOS transistor 21 is turned to an OFF state after time t4, the voltage V29 of the capacitor 29 is held at the level V292.

From time t5 to time t6, the MOS transistors 2, 4, 21 and 23 remain in an OFF state, and the MOS transistor 25 is in an ON state. At this time, the level V292 held in the capacitor 29 is supplied to the gate 28 of the MOS transistor 27, and the level V321 held in the capacitor 32 is supplied to the gate 31 of the MOS transistor 30. As a result, a current corresponding to the difference between the levels V321 and V292 flows to the MOS transistor 30, and the capacitor 33 is charged by the flowing current. The voltage V33 of the capacitor 33 rises from the initial level V331 by an amount corresponding to the magnitude of the charged current and a charging period T4, that is to say, the voltage V33 rises to a level V332.

From time t7 to time t8, the MOS transistors 2, 21 and 25 remain in an OFF state, and the MOS transistors 4 and 23 are in an ON state. As a result, the voltage VF of the floating diffusion F is brought to the reference level VR. The voltage V32 of the capacitor 32 is brought to the level V322, which is the reference level VR multiplied by the gain of the source follower. When the MOS transistor 23 is turned to an OFF state after time t8, the voltage V32 of the capacitor 32 is held at the level V322.

From time t9 to time t10, the MOS transistors 4, 23 and 25 remain in an OFF state, and the MOS transistors 2 and 21 are in an ON state. As a result, a charge generated by the photodiode 1 during exposure period T2 is transferred to the floating diffusion F. This causes the voltage VF of the floating diffusion F to fall from the reference level VR by an amount that corresponds to the amount of charge generated during the exposure period T2, that is to say, the voltage VF falls to a read level VF3. At this time, the MOS transistor 21 is in an ON state. As a result, the voltage V29 of the capacitor 29 is brought to a level V293, which is the read level VF3 multiplied by the gain of the source follower. When the MOS transistor 21 is turned to an OFF state after time t10, the voltage V29 of the capacitor 29 is held at the level V293.

From time t11 to time t12, the MOS transistors 2, 4, 21 and 23 remain in an OFF state, and the MOS transistor 25 is in an ON state. At this time, the level V293 held in the capacitor 29 is supplied to the gate 28 of the MOS transistor 27, and the level V322 held in the capacitor 32 is supplied to the gate 31 of the MOS transistor 30. As a result, a current corresponding to the difference between the levels V322 and V293 flows to the MOS transistor 30, and the capacitor 33 is charged by the flowing current. The voltage V33 of the capacitor 33 rises from the level V332 by an amount corresponding to the magnitude of the charged current and a charging period T5, that is to say, the voltage V33 rises to a level V333.

From time t13 to time t14, the MOS transistors 2, 21 and 25 remain in an OFF state, and the MOS transistors 4 and 23 are in an ON state. As a result, the voltage VF of the floating diffusion F is brought to the reference level VR. The voltage V32 of the capacitor 32 is brought to the level V323, which is the reference level VR multiplied by the gain of the source follower. When the MOS transistor 23 is turned to an OFF state after time t14, the voltage V32 of the capacitor 32 is held at the level V323.

From time t15 to time t16, the MOS transistors 4, 23 and 25 remain in an OFF state, and the MOS transistors 2 and 21 are in an ON state. As a result, a charge generated by the photodiode 1 during exposure period T3 is transferred to the floating diffusion F. This causes the voltage VF of the floating diffusion F to fall from the reference level VR by an amount that corresponds to the amount of charge generated during the exposure period T3, that is to say, the voltage VF falls to a read level VF4. At this time, the MOS transistor 21 is in an ON state. As a result, the voltage V29 of the capacitor 29 is brought to a level V294, which is the read level VF4 multiplied by the gain of the source follower. When the MOS transistor 21 is turned to an OFF state after time t16, the voltage V29 of the capacitor 29 is held at the level V294.

From time t17 to time t18, the MOS transistors 2, 4, 21 and 23 remain in an OFF state, and the MOS transistor 25 is in an ON state. At this time, the level V294 held in the capacitor 29 is supplied to the gate 28 of the MOS transistor 27, and the level V323 held in the capacitor 32 is supplied to the gate 31 of the MOS transistor 30. As a result, a current corresponding to the difference between the levels V323 and V294 flows to the MOS transistor 30, and the capacitor 33 is charged by the flowing current. The voltage V33 of the capacitor 33 rises from the level V333 by an amount corresponding to the magnitude of the charged current and a charging period T6, that is to say, the voltage V33 rises to a level V334.

The source follower constituted by the MOS transistors 13 and 14 outputs the voltage V16, which is the voltage V33 of the capacitor 33 multiplied by the gain. The voltage V16 is sampled by the noise cancelling circuit 93 at time t2 and time t18. The noise cancelling circuit 93 obtains a pixel signal by calculating a difference between level V161 at time t2 and level V162 at time t18.

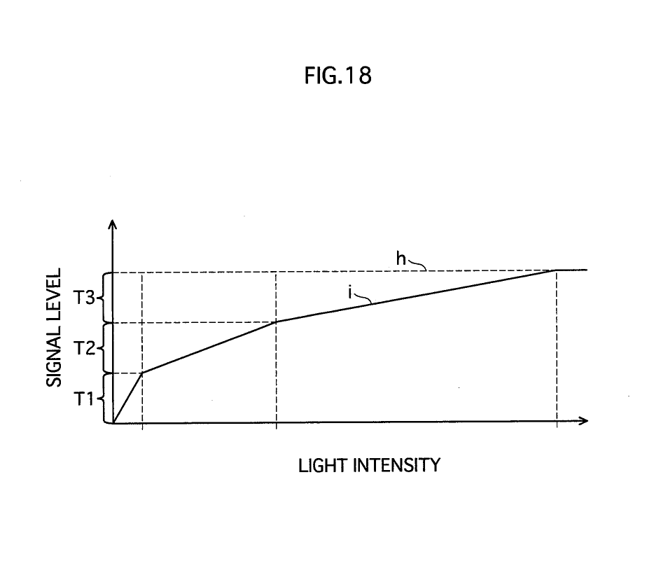

FIG. 18 shows a relationship between light intensity and signal level (after composition) in the imaging pixel 90 of embodiment 5.

A bent line i indicates signal level with respect to light intensity in the case of compositing the signal levels of exposure periods T1, T2 and T3. In embodiment 5, the lengths of the charging periods T4, T5 and T6 are the same. The signal levels in exposure periods T1, T2 and T3 therefore all have the same contribution rate in the composited signal level.

### Embodiment 6

In embodiment 6, the lengths of the charging periods T4, T5 and T6 are different. A description of other aspects has been omitted due to being the same as in embodiment 5.

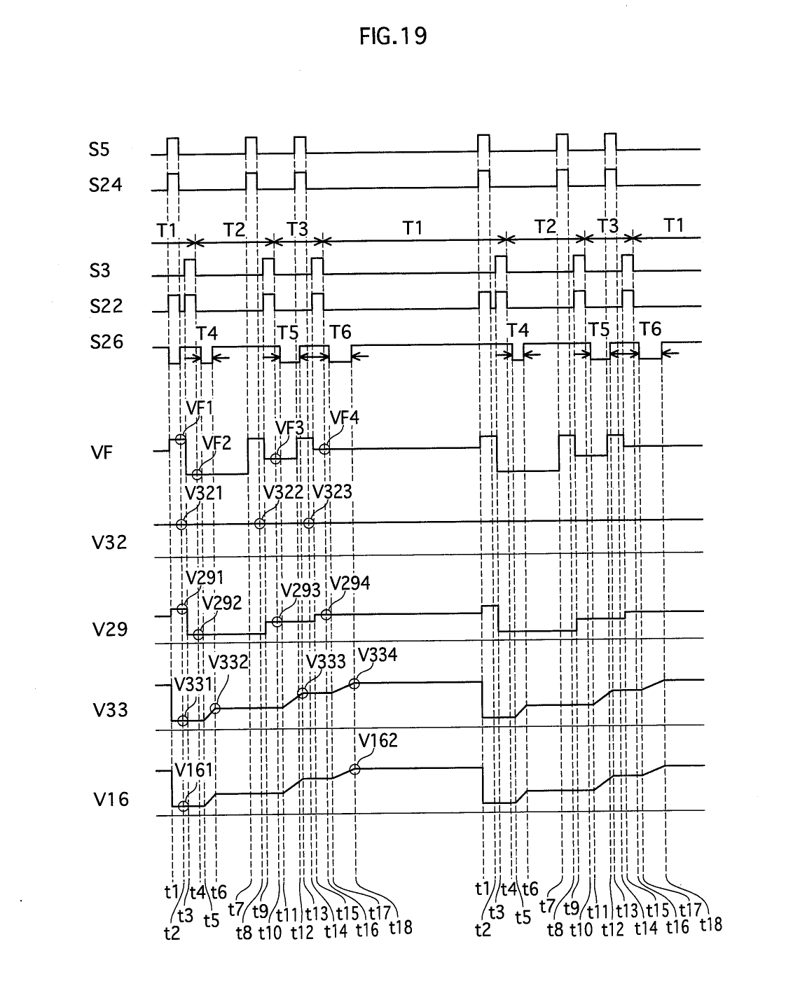

FIG. 19 is a timing chart showing driving signals for driving an imaging pixel 90 pertaining to embodiment 6 of the present invention, and voltage signals appearing at units of the imaging pixel 90 when being driven by the driving signals.

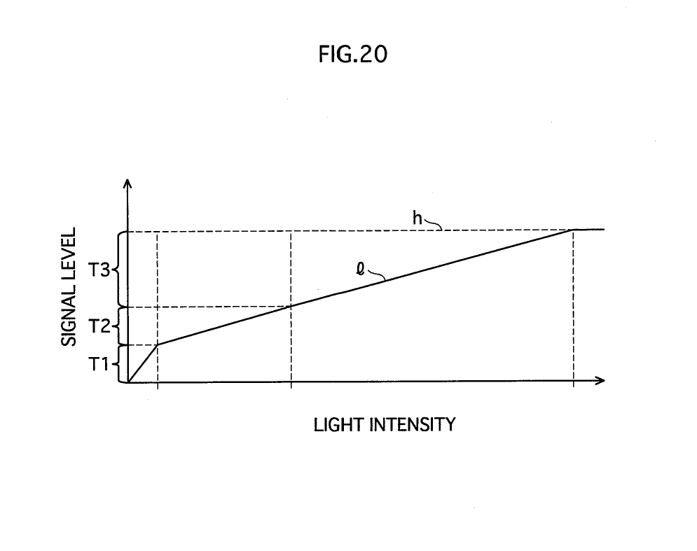

In embodiment 6, the lengths of the charging periods T4, T5 and T6 are different. Making the lengths of the charging periods enables making the signal levels of the exposure periods T1, T2 and T3 have different contribution rates in the composited signal level (see FIG. 20).

### Embodiment 7

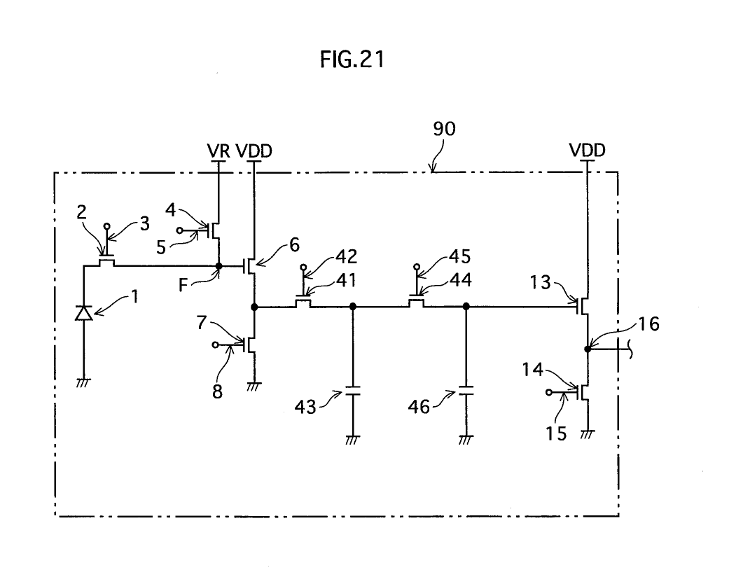

FIG. 21 shows the structure of an imaging pixel 90 pertaining to embodiment 7 of the present invention. The structure of the signal composition unit in embodiment 7 is different from embodiment 1. A description of other structures has been omitted due to being the same as in embodiment 1.

In the present embodiment, the signal composition unit includes MOS transistors 13, 14, 41 and 44, and capacitors 43 and 46. The MOS transistor 41 and capacitor 43 are provided on a path connecting the output node of a source follower constituted from the MOS transistors 6 and 7, and a ground. The MOS transistor 44 and capacitor 46 are provided on a path connecting a connection node between the MOS transistor 41 and the capacitor 43, and a ground. The MOS transistors 13 and 14 constitute a source follower. A power supply voltage VDD is supplied to the drain of the MOS transistor 13, and a voltage V46 is supplied from the capacitor 46 to the gate of the MOS transistor 13. A bias voltage is supplied to a gate 15 of the MOS transistor 14, and a ground voltage is supplied to the source of the MOS transistor 14. The source follower constituted by the MOS transistors 13 and 14 outputs a voltage V16, which is the voltage V46 of the capacitor 46 multiplied by the gain.

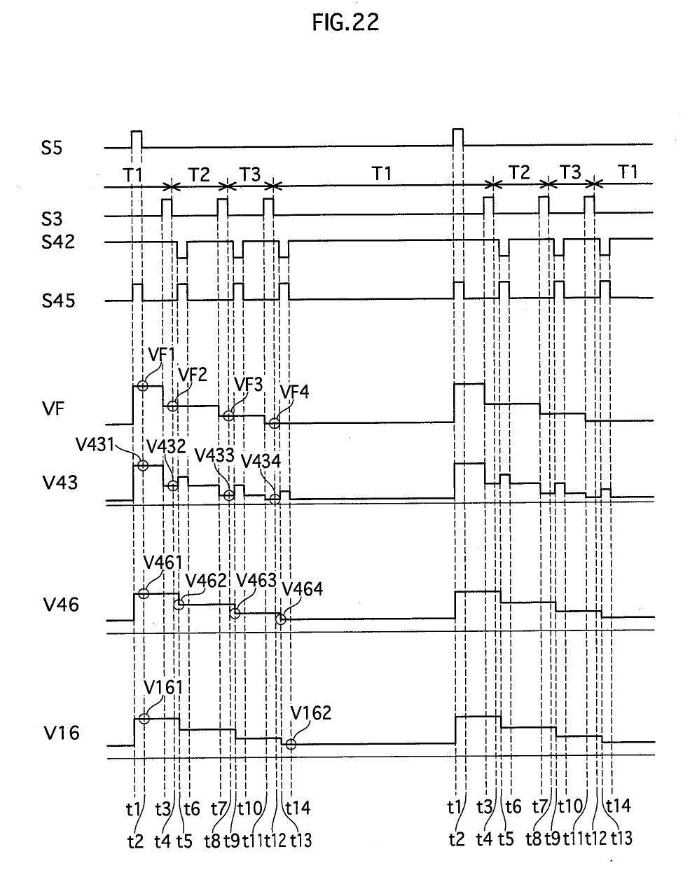

FIG. 22 is a timing chart showing driving signals for driving the imaging pixel 90 of embodiment 7, and voltage signals appearing at units of the imaging pixel 90 when being driven by the driving signals.

A driving signal S5 is a signal supplied to the gate 5 of an MOS transistor 4, a driving signal S3 is a signal supplied to the gate 3 of an MOS transistor 2, a driving signal S42 is a signal supplied to a gate 42 of the MOS transistor 41, and a driving signal S45 is a signal supplied to a gate 45 of the MOS transistor 44.

A voltage signal VF is a signal appearing at a floating diffusion F, a voltage signal V43 is a signal appearing at the capacitor 43, a voltage signal V46 is a signal appearing at the capacitor 46, and a voltage signal V16 is a signal appearing at the output node of the source follower constituted by the MOS transistors 13 and 14.

From time t1 to time t2, the MOS transistor 2 remains in an OFF state, and the MOS transistors 4, 41 and 44 are in an ON state. As a result, the voltage VF of the floating diffusion F is brought to a reference level VR. At this time, the voltage V43 of the capacitor 43 and the voltage V46 of the capacitor 46 are brought to levels V431 and V461 respectively, which are the reference level VR multiplied by the gain of the source follower. When the MOS transistor 44 is turned to an OFF state after time t2, the voltage V46 of the capacitor 46 is held at the level V461.

From time t3 to time t4, the MOS transistors 4 and 44 remain in an OFF state, and the MOS transistors 2 and 41 are in an ON state. As a result, a charge generated by the photodiode 1 during exposure period T1 is transferred to the floating diffusion F. This causes the voltage VF of the floating diffusion F to fall from the reference level VR by an amount that corresponds to the amount of charge generated during the exposure period T1, that is to say, the voltage VF falls to a read level VF2. At this time, the MOS transistor 41 is in an ON state. As a result, the voltage V43 of the capacitor 43 is brought to a level V432, which is the read level VF2 multiplied by the gain of the source follower.

From time t5 to time t6, the MOS transistors 2, 4 and 41 remain in an OFF state, and the MOS transistor 44 is in an ON state. At this time, the capacitors 43 and 46 become connected in parallel. As a result, the voltage V46 in the capacitor 46 is brought to a level V462, which is an average of the levels V432 and V461. When the MOS transistor 44 is turned to an OFF state after time t6, the voltage V46 of the capacitor 46 is held at level V462.

From time t7 to time t8, the MOS transistors 4 and 44 remain in an OFF state, and the MOS transistors 2 and 41 are in an ON state. As a result, a charge generated by the photodiode 1 during exposure period T2 is transferred to the floating diffusion F. This causes the voltage VF of the floating diffusion F to fall from the reference level VR by an amount that corresponds to the amount of charge generated during the exposure period T2, that is to say, the voltage VF falls to a read level VF3. At this time, the MOS transistor 41 is in an ON state. As a result, the voltage V43 of the capacitor 43 is brought to a level V433, which is the read level VF3 multiplied by the gain of the source follower.

From time t9 to time t10, the MOS transistors 2, 4 and 41 remain in an OFF state, and the MOS transistor 44 is in an ON state. At this time the capacitors 43 and 46 become connected in parallel. As a result, the voltage V46 in the capacitor 46 is brought to a level V463, which is an average of the levels V433 and V462. When the MOS transistor 44 is turned to an OFF state after time t10, the voltage V46 of the capacitor 46 is held at level V463.

From time till to time t12, the MOS transistors 4 and 44 remain in an OFF state, and the MOS transistors 2 and 41 are in an ON state. As a result, a charge generated by the photodiode 1 during exposure period T3 is transferred to the floating diffusion F. This causes the voltage VF of the floating diffusion F to fall from the reference level VR by an amount that corresponds to the amount of charge generated during the exposure period T3, that is to say, the voltage VF falls to a read level VF4. At this time, the MOS transistor 41 is in an ON state. As a result, the voltage V43 of the capacitor 43 is brought to a level V434, which is the read level VF4 multiplied by the gain of the source follower.

From time t13 to time t14, the MOS transistors 2, 4 and 41 remain in an OFF state, and the MOS transistor 44 is in an ON state. At this time, the capacitors 43 and 46 become connected in parallel. As a result, the voltage V46 in the capacitor 46 is brought to a level V464, which is an average of the levels V434 and V463. When the MOS transistor 44 is turned to an OFF state after time t14, the voltage V46 of the capacitor 46 is held at level V464.

The source follower constituted by the MOS transistors 13 and 14 outputs the voltage V16, which is the voltage V46 of the capacitor 46 multiplied by the gain. The voltage V16 is sampled by the noise cancelling circuit 93 at time t2 and time t14. The noise cancelling circuit 93 obtains a pixel signal by calculating a difference between level V161 at time t2 and level V162 at time t14.

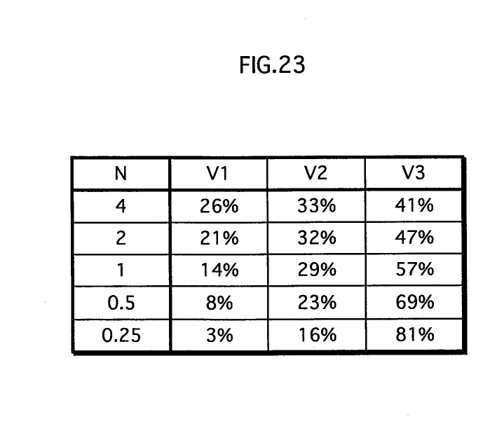

FIG. 23 shows the contribution rates of signal levels V1, V2 and V3 from exposure periods T1, T2 and T3 respectively.

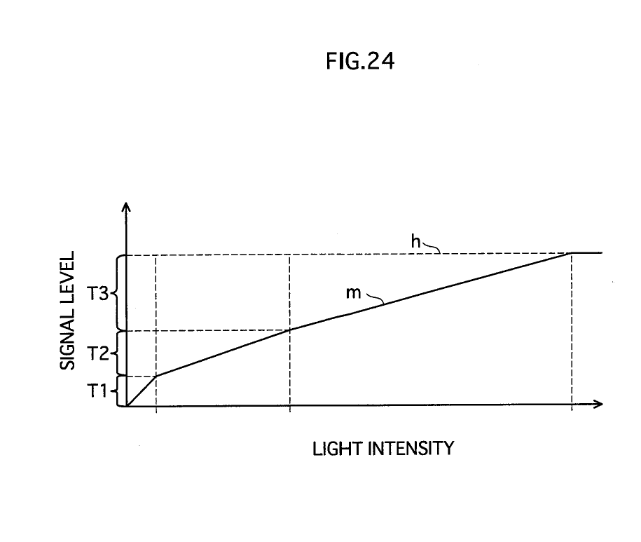

The contribution rates of the signals levels V1, V2 and V3 vary in correspondence with a capacitance ratio N of the capacitor 43 to the capacitor 44. For example, when N is 2, that is to say when the capacitance of the capacitor 46 is twice the capacitance of the capacitor 43, the contribution rates of the signal levels V1, V2 and V3 are in a ratio of 21:32:47 (see FIG. 24).

### Embodiment 8

Embodiment 8 describes an MOS solid state imaging device that combines the signals levels from the exposure periods T1, T2 and T3.

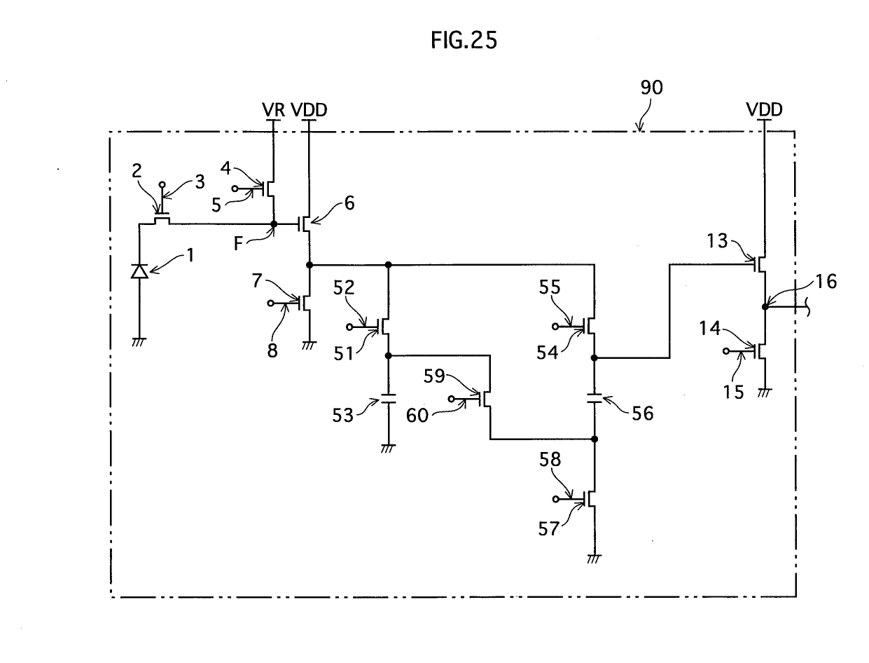

FIG. 25 shows the structure of an imaging pixel 90 pertaining to embodiment 8 of the present invention.

The structure of the signal composition unit in embodiment 8 is different from embodiment 1. A description of other structures has been omitted due to being the same as in embodiment 1.

In the present embodiment, the signal composition unit includes MOS transistors 13, 14, 51, 54, 57 and 59, and capacitors 53 and 56. The MOS transistor 51 and capacitor 53 are provided on a path connecting the output node of a source follower constituted from MOS transistors 6 and 7, and a ground. The MOS transistor 54, the capacitor 56, and the MOS transistor 57 are provided on a path connecting the output node of the source follower constituted by the MOS transistors 6 and 7, and a ground. The MOS transistor 59 is provided on a path connecting a power supply terminal of the capacitor 53 and a ground terminal of the capacitor 56. The MOS transistors 13 and 14 constitute a source follower. A power supply voltage VDD is supplied to the drain of the MOS transistor 13, and a voltage V56 is supplied from the capacitor 56 to the gate of the MOS transistor 13. A bias voltage is supplied to the gate of the MOS transistor 14, and a ground voltage is supplied to the source of the MOS transistor 14. The source follower constituted by the MOS transistors 13 and 14 outputs a voltage V16, which is the voltage V56 of the capacitor 56 multiplied by the gain.

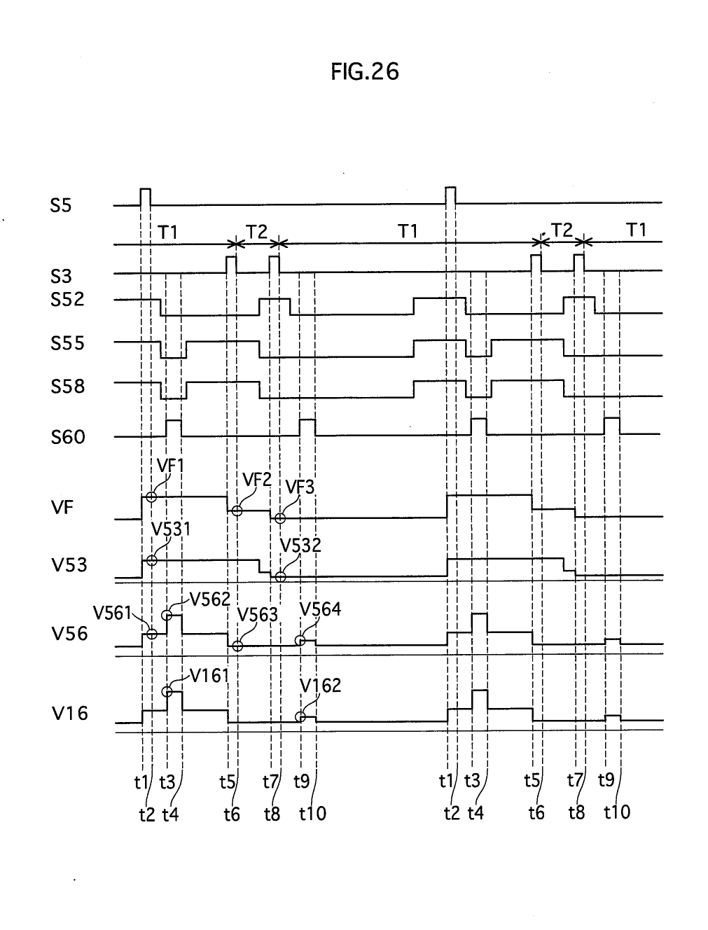

FIG. 26 is a timing chart showing driving signals for driving the imaging pixel 90 of embodiment 8, and voltage signals appearing at units of the imaging pixel 90 when being driven by the driving signals.

A driving signal S5 is a signal supplied to a gate 5 of an MOS transistor 4, a driving signal S3 is a signal supplied to a gate 3 of an MOS transistor 2, a driving signal S52 is a signal supplied to a gate 52 of the MOS transistor 51, a driving signal S55 is a signal supplied to a gate 55 of the MOS transistor 54, a driving signal S58 is a signal supplied to a gate 58 of the MOS transistor 57, and a driving signal S60 is a signal supplied to a gate 60 of the MOS transistor 59.

A voltage signal VF is a signal appearing at a floating diffusion F, a voltage signal V53 is a signal appearing at the capacitor 53, a voltage signal V56 is a signal appearing at the capacitor 56, and a voltage signal V16 is a signal appearing at the output node of the source follower constituted by the MOS transistors 13 and 14.

From time t1 to time t2, the MOS transistors 2 and 59 remain in an OFF state, and the MOS transistors 4, 51, 54 and 57 are in an ON state. As a result, the voltage VF of the floating diffusion F is brought to a reference level VR. The voltage V53 of the capacitor 53 and the voltage V56 of the capacitor 56 are brought to levels V531 and V561 respectively, which are the reference level VR multiplied by the gain of the source follower. When the MOS transistors 51 and 54 are turned to an OFF state after time t2, the voltage V56 of the capacitor 56 is held at the level V561.

From time t3 to time t4, the MOS transistors 2, 4, 51, 54 and 57 remain in an OFF state, and the MOS transistor 59 is in an ON state. At this time, the capacitors 53 and 56 become connected in series. As a result, the voltage V56 of the capacitor 56 is brought to a level V562, which is a combination of the levels V531 and V561.

From time t5 to time t6, the MOS transistors 4, 51 and 59 remain in an OFF state, and the MOS transistors 2, 54 and 57 are in an ON state. As a result, a charge generated by the photodiode 1 during exposure period T1 is transferred to the floating diffusion F. This causes the voltage VF of the floating diffusion F to fall from the reference level VR by an amount that corresponds to the amount of charge generated during the exposure period T1, that is to say, the voltage VF falls to a read level VF2. At this time, the MOS transistor 54 is in an ON state. As a result, the voltage V56 of the capacitor 56 is brought to a level V563, which is the read level VF2 multiplied by the gain of the source follower. When the MOS transistor 54 is turned to an OFF state after time t6, the voltage V56 of the capacitor 56 is held at the level V563.

From time t7 to time t8, the MOS transistors 4, 54, 57 and 59 remain in an OFF state, and the MOS transistors 2 and 51 are in an ON state. As a result, a charge generated by the photodiode 1 during exposure period T2 is transferred to the floating diffusion F. This causes the voltage VF of the floating diffusion F to fall from the reference level VR by an amount that corresponds to the amount of charge generated during the exposure period T2, that is to say, the voltage VF falls to a read level VF3. At this time, the MOS transistor 51 is in an ON state. As a result, the voltage V53 of the capacitor 53 is brought to a level V532, which is the read level VF3 multiplied by the gain of the source follower. When the MOS transistor 51 is turned to an OFF state after time t8, the voltage V53 of the capacitor 53 is held at the level V532.

From time t9 to time t10, the MOS transistors 2, 4, 51, 54 and 57 remain in an OFF state, and the MOS transistor 59 is in an ON state. At this time, the capacitors 53 and 56 become connected in series. As a result, the voltage V56 of the capacitor 56 is brought to a level V564, which is a combination of the levels V532 and V563.

The source follower constituted by the MOS transistors 13 and 14 outputs the voltage V16, which is the voltage V56 of the capacitor 56 multiplied by the gain. The voltage V16 is sampled by the noise cancelling circuit 93 at time t3 and time t9. The noise cancelling circuit 93 obtains a pixel signal by calculating a difference between level V161 at time t3 and level V162 at time t9.

The present invention is applicable to the fields of digital cameras, mobile phone internal cameras, vehicle-mounted cameras, surveillance cameras, and the like.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. A solid state imaging device including a plurality of pixels, each pixel including:
a photodiode that generates a charge in accordance with an intensity of incident light;
a signal generation unit whose circuit structure includes a source follower, the signal generation unit being operable to, in a frame period, output from the source follower (i) a first voltage signal that corresponds to an amount of charge generated by the photodiode in a first exposure period and (ii) a second voltage signal that corresponds to an amount of charge generated by the photodiode in a second exposure period whose length is different from a length of the first exposure period; and
a signal composition unit whose circuit structure includes one or more capacitors that hold the first voltage signal and second voltage signal output from the source follower, the signal composition unit being operable to composite the first voltage signal and second voltage signal held in the one or more capacitors.

2. The solid state imaging device of claim 1, wherein
the signal composition unit (i) causes the first voltage signal to be held in a first capacitor from among the one or more capacitors, (ii) causes the second voltage signal to be held in a second capacitor from among the one or more capacitors, the first capacitor and the second capacitor having a same capacitance, and (iii) causes the first capacitor holding the first voltage signal and the second capacitor holding the second voltage signal to be connected in parallel.

3. The solid state imaging device of claim 1, wherein
when performing the composition, the signal composition unit gives a predetermined weight to the first voltage signal and a predetermined weight to the second voltage signal.

4. The solid state imaging device of claim 3, wherein
the signal composition unit (i) causes the first voltage signal to be held in a first capacitor from among the one or more capacitors, (ii) causes the second voltage signal to be held in a second capacitor from among the one or more capacitors, the first capacitor and second capacitor having a different capacitance, and (iii) causes the first capacitor holding the first voltage signal and the second capacitor holding the second voltage signal to be connected in parallel.

5. The solid state imaging device of claim 4, wherein
the signal composition unit includes a plurality of the capacitors, each of the plurality of capacitors having a same capacitance,
the first capacitor is connected in parallel with a first number of capacitors from among the plurality of capacitors, and
the second capacitor is connected in parallel with a second number of capacitors from among the plurality of capacitors, the first number of capacitors and second number of capacitors being different in number.

6. The solid state imaging device of claim 3, wherein
the signal composition unit is further operable to arbitrarily change the predetermined weight of the first voltage signal and the predetermined weight of the second voltage signal.

7. The solid state imaging device of claim 6, wherein
in a first mode of the signal composition unit, the signal composition unit (i) causes the first voltage signal to be held in a first capacitor from among the one or more capacitors, (ii) causes the second voltage signal to be held in a second capacitor from among the one or more capacitors, a capacitance of the second capacitor being smaller than a capacitance of the first capacitor, and (iii) causes the first capacitor holding the first voltage signal and the second capacitor holding the second voltage signal to be connected in parallel, and
in a second mode of the signal composition unit, the signal composition unit causes the first voltage signal to be held in the second capacitor, causes the second voltage signal to be held in the first capacitor, and causes the first capacitor holding the second voltage signal and the second capacitor holding the first voltage signal to be connected in parallel.

8. The solid state imaging device of claim 6, wherein
the signal composition unit includes a plurality of the capacitors, each of the plurality of capacitors having a same capacitance,
in a first mode of the signal composition unit, the signal composition unit (i) causes the first voltage signal to be held in a first number of capacitors from among the plurality of capacitors, (ii) causes the second voltage signal to be held in a second number of capacitors from among the plurality of capacitors, the second number of capacitors being smaller in number than the first number of capacitors, and (iii) causes the first number of capacitors holding the first voltage signal and the second number of capacitors holding the second voltage signal to be connected in parallel, and
in a second mode of the signal composition unit, the signal composition unit (iv) causes the first voltage signal to be held in a third number of capacitors from among the plurality of capacitors, (v) causes the second voltage signal to be held in a fourth number of capacitors from among the plurality of capacitors, the fourth number of capacitors being greater in number than the third number of capacitors, and (vi) causes the third number of capacitors holding the first voltage signal and the fourth number of capacitors holding the second voltage signal to be connected in parallel.

9. The solid state imaging device of claim 1, wherein
in the signal composition unit, one of the one or more capacitors is a signal holding capacitor, and another one of the one or more capacitors is a signal composition capacitor, and
the signal composition unit (i) causes the first voltage signal to be held in the signal holding capacitor, (ii) in a first charging period, causes the signal composition capacitor to be charged by a first current that corresponds to the first voltage signal held in the signal holding capacitor, (iii) causes the second voltage signal to be held in the signal holding capacitor after the first charging period has elapsed, and (iv) in a second charging period whose length is the same as a length of the first charging period, causes the signal composition capacitor to be further charged by a second current that corresponds to the second voltage signal.

10. The solid state imaging device of claim 1, wherein
in the signal composition unit, one of the one or more capacitors is a signal holding capacitor, and another one of the one or more capacitors is a signal composition capacitor, and
the signal composition unit (i) causes the first voltage signal to be held in the signal holding capacitor, (ii) in a first charging period, causes the signal composition capacitor to be charged by a first current that corresponds to the first voltage signal held in the signal holding capacitor, (iii) causes the second voltage signal to be held in the signal holding capacitor after the first charging period has elapsed, and (iv) in a second charging period whose length is different from the first charging period, causes the signal composition capacitor to be further charged by a second current that corresponds to the second voltage signal held in the signal holding capacitor.

11. The solid state imaging device of claim 1, wherein
in the signal composition unit, one of the one or more capacitors is a signal holding capacitor, and another one of the one or more capacitors is a signal composition capacitor, and
the signal composition unit (i) causes the first voltage signal to be held in the signal holding capacitor, (ii) causes the signal composition capacitor and the signal holding capacitor that is holding the first voltage signal to be connected in parallel for only a certain time period, (iii) after the time period has elapsed, causes the second voltage signal to be held in the signal holding capacitor, and (iv) causes the signal composition capacitor holding a voltage signal based on the first voltage signal and the signal holding capacitor holding the second voltage signal to be connected in parallel.

12. The solid state imaging device of claim 1, wherein
the signal composition unit causes the first voltage signal to be held in a first capacitor from among the one or more capacitors, causes the second voltage signal to be held in a second capacitor from among the one or more capacitors, and causes the first capacitor holding the first voltage signal and the second capacitor holding the second voltage signal to be connected in series.

13. A camera including a solid state imaging device, the solid state imaging device including a plurality of pixels, each pixel including
a photodiode that generates a charge in accordance with an intensity of incident light;
a signal generation unit whose circuit structure includes a source follower, the signal generation unit being operable to, in a frame period, output from the source follower (i) a first voltage signal that corresponds to an amount of charge generated by the photodiode in a first exposure period and (ii) a second voltage signal that corresponds to an amount of charge generated by the photodiode in a second exposure period whose length is different from a length of the first exposure period; and
a signal composition unit whose circuit structure includes one or more capacitors that hold the first voltage signal and second voltage signal output from the source follower, the signal composition unit being operable to composite the first voltage signal and second voltage signal held in the one or more capacitors.
